(19) United States
(12) Patent Application Publication
(10) Pub. No.: US 2024/0009681 A1
(43) Pub. Date: Jan. 11, 2024

(54) LIBERATION, SEPARATION, AND CONCENTRATION OF HALLOYSITE FROM A COMPOSITE NATURAL OR SYNTHETIC MINERAL RESOURCE

(71) Applicant: The Ginn Technology Group, Sandersville, GA (US)

(72) Inventors: Michael Warren Ginn, Sandersville, GA (US); Whitney Jones, Mitchell, GA (US); John Mason, Sandersville, GA (US)

(73) Assignee: The Ginn Technology Group, Sandersville, GA (US)

(21) Appl. No.: 18/350,110

(22) Filed: Jul. 11, 2023

Related U.S. Application Data
(60) Provisional application No. 63/388,162, filed on Jul. 11, 2022.

(51) Int. Cl. B03B 9/00; C01B 33/40

(52) U.S. Cl. CPC B03B 9/00; C01B 33/40; C01P 2006/80; C01P 2004/02; C01P 2004/03

(57) ABSTRACT

A system for processing halloysite from primary and/or secondary global mineral deposits comprising liberating, separating and concentrating processes, and a halloysite product produced therefrom. The system selectively measures the particle size distribution determining halloysite concentration and impurity removal success, significantly increases in halloysite mining/mineral reserves. The halloysite product produced has purity, consistency and homogeneity on commercial scales, and with improved particle morphology and enhanced product performance and can be used for a range of high value applications.

### BACKGROUND OF THE INVENTION

### Technical Field

The present disclosure is generally directed to a system for, and a method of, processing a natural or synthetic mineral resource matrix, such as clay, and extracting a component from the matrix without chemical change to the component. The present disclosure also is generally directed to a system for, and a method of, evaluating, measuring, testing, and quantifying the mineral components within a natural or synthetic mineral resource matrix.

### Prior Art

Halloysite is a clay mineral made up of double-layered aluminosilicate nanostructures, defining a predominantly hollow tubular interior (the lumen), in the submicron range. Its main constituents are aluminum, silicon, and hydrogen. Halloysite typically forms from the hydrothermal alteration of aluminosilicate minerals. The mineral “halloysite” is commonly referred to as halloysite nanotubes (HNT's), and is characterized as having a unique morphological characteristic, brightness characteristic, and surface-size characteristic. Most natural deposits of halloysite are associated with other clay minerals (e.g., dickite, kaolinite, montmorillonite, and others) and are part of a mineral resource matrix.

For example, the weathering of sodium/potassium feldspar results in the formation of clay minerals such as illite, kaolinite, and halloysite, with halloysite being characterized with the formula Al₂Si₂O₅(OH)₄·2H₂O and kaolinite being characterized with the formula Al₂Si₂O₅(OH)₄. The crystal structure differences are important and control properties relevant to their commercial applications.

Kaolinite typically occurs in platy forms, or as distinct platelets. Halloysite, on the other hand, has a similar plate-like crystal form except that it contains additional water molecules or other imperfections in the crystal lattice, which cause the crystal to “roll up” into a tubular or spheroid morphology. There are two varieties of halloysite, the fully hydrated, 10 Å variety and the partially hydrated, 7 Å variety. Halloysite easily loses its interlayer water, so it often is observed in a partly dehydrated state in a natural mineral resource matrix.

Kaolinite is an important raw industrial mineral commonly used in the ceramic and fine-porcelain industry, and halloysite is becoming increasingly important due to its biodegradable tubular morphology and use in the nanotechnology industry. Large quantities of kaolinite are used in paper coating, filler, paint, plastics, fiberglass, catalysts, and other specialty applications. It is also used as a key ingredient in natural pesticides that are suitable for organic farming applications.

Metakaolin is the anhydrous partially calcined form of kaolinite (or halloysite). Metakaolin particles are nearly ten times smaller than cement particles, which enables the production of a denser, more impervious concrete, that is more durable and also has superior mechanical properties, than concrete produced by conventional cement. The particle size of metakaolin is smaller than cement particles, but not as fine as silica fume or fly ash; therefore, metakaolin is useful in resolving certain environmental issues related to cement production.

On the other hand, owing to the layered structure of the halloysite, halloysite has a large specific surface area that can reach upwards of about 117 meters squared per gram (m²/g). Therefore, halloysite is an efficient capture platform both for cations and anions. Halloysite also can be intercalated with catalytic metal nanoparticles made of silver, ruthenium, rhodium, platinum, or cobalt, to serve as a catalyst.

More specifically, as further differentiation between kaolinite and halloysite, kaolinite does not contain interlayer cations or interlayer water. Kaolinite is a layered silicate mineral, with one tetrahedral sheet of silica (SiO₄) linked through oxygen atoms to one octahedral sheet of alumina (AlO₆). The temperature of dihydroxylation for kaolinite depends on the structural layer stacking order. Disordered kaolinite generally dehydroxylates between about 530 degrees Celsius (° C.) and about 570° C., and ordered kaolinite generally dehydroxylates between about 570° C. and about 630° C. Above these temperature ranges, kaolinite transforms into metakaolin, where much of the aluminum of the octahedral layer becomes tetrahedrally and pentahedrally coordinated.

The resulting metakaolin is a complex amorphous structure that exhibits exceptional pozzolanic features and that retains long-range order due to its stacked layers. The dehydroxylation of kaolinite to metakaolin, therefore, is an endothermic process characterized by the large amount of energy-heat required to remove the chemically bonded hydroxyl ions from the raw kaolinite. In order to produce pozzolanic metakaolin, which can function as a supplementary cementitious material, for example, nearly complete dehydroxylation of the raw kaolinite must be obtained without overheating the raw kaolinite, i.e., thoroughly roasting but not burning the kaolinite. This produces an amorphous silicate-based material that consumes calcium hydroxide or lime to produce additional calcium silicate hydrate, whereas overheating causes sintering that produces a dead, burnt, nonreactive refractory mineral, containing mullite and a defective aluminosilicate spinel, in some instances. It is well known that dehydroxylated disordered kaolinite shows higher pozzolanic activity than dehydroxylated ordered kaolinite.

Halloysite, on the other hand, naturally occurs as small cylinders, or nanotubes, that have a wall thickness of between about 10 to about 15 atomic alumosilicate sheets, an outer diameter of between about 50 nanometers (nm) to about 500 nm, an inner diameter of between about 12 nm to about 15 nm, and a length of between about 0.5 micrometers (μm) to about 10 μm. Their outer surface is mostly composed of SiO₂ and the inner surface is mostly composed of Al₂O₃; hence, those surfaces are oppositely charged. Two common forms of halloysite are naturally found. When hydrated, the clay mineral exhibits an about 1 nm spacing of the layers, and when dehydrated, known as meta-halloysite, the spacing is about 0.7 nm. The cation exchange capacity depends on the amount of hydration, as the 2H₂O has between about 5 milliequivalents per gram (meq/100 g) to about 10 meq/100 g, while the 4H₂O has between about 40 meq/100 g to about 50 meq/100 g. Endellite is the alternative name for the Al₂Si₂O₅(OH)₄·2H₂O structure.

It is possible, due to the existence of waste dumps, mine waste, carpet processing plants, and paper processing plants, for example, that halloysite and/or related kaolinite deposits may be part of a synthetic mineral resource matrix of refuse material, for example.

Many grades of paper contain functional mineral pigments, fillers, and/or additives, such as kaolin clays, calcium carbonate, titanium silicates and dioxides, etc., which are incorporated into the paper when it is made, or which are superficially incorporated onto the paper thereafter. During the course of manufacturing paper and similar products, including paper board and the like, it is common and well known to incorporate quantities of inorganic materials into the fibrous web in order to improve the quality of the resulting paper product. A number of inorganic materials, such as titanium dioxide, have long been known to be effective for these purposes. For example, titanium dioxide is recognized as providing the maximum brightness and opacity development of all commercially available paper pigments. These materials can be incorporated into the paper in the form of anatase or rutile.

Titanium dioxide, however, is among the most expensive materials available for this purpose. Accordingly, in recent years, considerable efforts have been made to develop satisfactory replacements for titanium dioxide. Based on their superior optical properties, calcined kaolin clays and, in special cases, halloysite clays have proven to be very effective titanium dioxide extenders and have enjoyed wide acceptance in the paper, paint, and plastics industries.

Among the materials that have found increasing acceptance as paper fillers are substantially anhydrous kaolin clays. Materials of this type are generally prepared by partially or fully calcining a crude kaolin clay, which may have been subjected to prior beneficiation steps in order to remove certain impurities, such as, for example, for the purpose of improving brightness in the ultimate product.

The literature relating to the field of kaolinite products and processing, often uses the term “hydrous” to refer to a kaolin clay which has not been subjected to calcination, specifically, which has not been heated to temperatures above about 450° C. Such temperatures serve to alter the basic crystal structure of kaolin clays. These so-called “hydrous” clays may be produced from crude kaolins, which have been subjected to various operations of beneficiation, for example froth flotation, magnetic separation, mechanical delamination, grinding, or comminution, but not to such heating as would impair the crystal structure.

Once the kaolin clay is subjected to calcination, which, for the purposes of this disclosure, means being subjected to heating of 450° C. or higher for a period that eliminates the hydroxyl groups, the crystalline structure of the kaolin clay components are expected to be destroyed. Preferably, the calcined kaolin clay has been heated above the 980° C. exotherm, and therefore is “fully calcined”, as opposed to having been rendered a “metakaolin”, as also is used and described herein.

Generally, with regard to the paper waste processing, there has been no practical method of separating the mineral pigments from the organic portion of the waste such that the mineral pigments can be reused. The prior art generally teaches that the wastes from papermaking or from recycling paper waste are best incinerated, and that the residue of the incineration are best landfilled.

With regard to carpet waste, the used and discarded carpet processing streams also are a potentially valuable mineral resource matrix. Typical whole carpet construction contains various fiber types that are tufted into a primary backing that is bound as a structural system by a back coating. Primary and secondary back coatings contain various polymers and fillers, such as styrene-butadiene rubber (SBR), ethylene vinyl acetate (EVA), polyethylene terephthalate (PET), polyvinyl chloride (PVC), calcium carbonate, clay, and glass. In simple terms, the face of the carpet is woven through a backing fabric and held in-place by an “adhesive” which is often a latex cross-linked polymer or thermoresin loaded with calcium carbonate and/or other mineral filler materials.

The term “carpet third stream” is frequently used in the field in connection with post-consumer and post-industrial materials, and in general, refers to a waste stream of recovered materials containing the highest concentrations of fillers and binders, and, optionally, filler wetting agents, which are extracted from the recycling of whole carpet and the recovery of energy.

Presently, from the perspective of “purity”, most known commercial-scale halloysite deposits are contaminated with other clay and country-rock minerals and/or kaolinitic materials, such as kaolinite. For example, drill cores of known natural halloysite deposits generally show that kaolinite is ubiquitous, but decreasing with depth, and that there are decreasing loss-on-ignition measurements with depth for the kaolinite, for example. The halloysite (>50%) is commonly found in pods or zones no greater than about 10 acres in size of a total clay fraction. Kaolinite abundance in the clay fraction may range between about 40 percent (%) to about 100%, while halloysite abundance may range between about 58% to about 0%, respectively.

This contamination issue tends to limit the commercial applications and value of the halloysite deposit. This is especially true for the New Zealand halloysite deposit, which is the largest and most renowned commercial deposit on the planet. Due to the parent country-rock of the New Zealand halloysite deposit, and due to centuries of hydrothermal alteration, amorphous silica and allophane components also contaminate the halloysite deposit and are present in substantial quantities. Another renowned halloysite deposit, situated beneath the Dragon mine in the state of Utah, also is contaminated.

Consequently, most relevant commercial mining and processing operations involve conventional or rudimentary processing systems and methods to liberate, separate, and concentrate pure halloysite and the other commercially-valuable components from the remainder of the relevant mineral resource matrix. Quartz, potassium feldspar, halloysite, and kaolinite processing are upgraded by improved processing methods that yield high purity levels, as the purity of the starting material yields, respectively, the most efficient and effective path to the final desired product.

For example, quartz—SiO₂ or silicon dioxide—is known for its hardness and its use in glass production; however, different types of glass require different purity levels, with some types of glass requiring the silicon dioxide content in the quartz to have purity levels in between about 97% to about 99% to be suitable, i.e., non-silicon dioxide contaminants ranging from about 1500 parts per million (ppm) to about 10 ppm. Similarly, potassium feldspar is primarily used in ceramic bodies and glazes and those applications usually demand potassium feldspar with purities of between about 12.2% to about 13.1% potassium oxide with low iron and high alumina. A high-quality final product of potassium feldspar product usually has relatively high potassium oxide, high alumina, and cannot contain excessive mineral inclusions and iron in the crystal lattice, i.e., less than about 0.1% iron as iron oxide. Similarly, kaolinite is primarily and commonly processed via heating to about 850° C. to form the dehydrated metakaolin phase, and this transformation is made most efficient and most effective when the input kaolinite is as pure and free of contamination as possible.

From the perspective of halloysite, most commercial halloysite mining and processing operations rely on the purity of the specific in-ground halloysite vein/pod being target (relative to the broader mineral deposit) to obtain as pure a halloysite as possible, and most rely on basic processing techniques comprising nothing more than drying and pulverizing the raw dry clay. Usually, in the halloysite purification prior art, the starting kaolin clay material is processed in a non-fluid state with a simple centrifuge-based systems. These modest processing techniques limit the value and commercial application of the resulting mined halloysite product.

In the limited instances where fluid or wet processing of the kaolin clay is employed, the expected processing technique comprises flocculating to lower the pH, and dewatering/filtration, ultimately causing particles and agglomerates to bind and separate into layers. This produces what is considered in the prior art as a halloysite final product; however, its level of purity does not rise to the level yielded by the method/system described herein.

A resulting mined and processed halloysite product, if of sufficient purity, has a wide range of applications in the manufacture of porcelain, bone china, and fine china, where the combination of low iron and titanium content together with the hollow tubular morphology of the mineral grains yields ceramic bodies with exceptional whiteness and translucency, and in the commercial production of suspension agents for glaze preparations, as well as in filters and inkjets and as ingredients in special paints applied to ships to prevent barnacles from growing. The resulting mined halloysite product, if of sufficient purity, also is being increasingly used in plastic and polymer applications where the addition of the nanosized tubular morphology increases strength while reducing the weight of these compounds. Perhaps the most innovating uses for the resulting mined halloysite product, if of sufficient purity, are in life-science application where the inside of the hollow tube, the lumen, may be filled with active ingredients and as the clay tube erodes the active ingredients are released or discharged. Used in this manner the halloysite nanotubes are a delivery vector made of natural materials.

As halloysite is a naturally occurring, eco-friendly, low production-cost nanostructure that is nontoxic to humans in the most commonly expected concentrations and dosages, halloysite can function as a unique morphological capture platform or chemical precursor. The halloysite capture platform or chemical precursor may be used in a variety of applications, including (1) controlled-release applications, (2) ceramic and porcelain applications, (3) pharmaceutical applications, (4) pesticide applications, (5) personal care applications, (6) nano-container applications, (7) nano-reactor applications, etc.

Presently, the presence and concentration of kaolinite and halloysite in a kaolin clay mineral resource matrix is measured by a variety of methods. Because of the close similarity in chemical composition and properties of halloysite and kaolinite, quantitative mineralogical analysis of these two minerals in the same matrix is difficult. With the exception of porcelain-like halloysite, the sample usually must be analyzed ex situ to detect the presence of halloysite. Electron microscope analysis is the principal tool most utilized in the field for this purpose, although petrographic microscope, x-ray diffraction, and differential thermal analysis procedures also have been used to determine the presence of halloysite. Thin-section point-count technique, base-exchange determination methods, electron microscope techniques, and infrared absorption spectra analysis also have been used.

### BRIEF SUMMARY OF THE INVENTION

The present disclosure provides and teaches a halloysite kaolin separation (HKS) system, that is a wet processing system that (a) optimizes the intrinsic buoyancy forces (Fb) of halloysite; (b) concentrates halloysite from other minerals/contaminates with a separate system, via static and/or dynamic reactors, and (c) quantifies the success of the process applying novel laboratory techniques. The HKS of the present disclosure economically liberates, separates, and concentrates halloysite from primary and secondary global mineral deposits. The specially designed mechanical/hydraulic reactors in the HKS with optimized operating parameters transform the composite mineral slurries into high purity halloysite products.

The HKS of the present disclosure also selectively measures the particle size distribution determining halloysite concentration and impurity removal success. The halloysite concentration provides product with high product purity, consistency, and homogeneity on commercial scale It can also significantly increase in halloysite mining/mineral reserves, enhances product performance, improves particle morphology (i.e., less broken crystals reducing performance), and provides a very high quality halloysite precursor and platform for a range of high value applications.

The HKS of the present invention is global in nature in that the process can be carried out in one country with starting materials found in that country or other countries. For example, for crude mined in one country, the HKS process can be performed in another country. Thus, the process taught herein is useful for commercial deposits of halloysite located in a range of geological and geographical environments. Thus, the HKS halloysite process is very flexible and adaptable so that crude halloysite can be mined in one geographical location and processed in different locations, including in different countries.

One embodiment of the invention is a system for processing halloysite from primary and/or secondary global mineral deposits, comprising liberating, separating and concentrating processes.

Another embodiment of the invention comprises mineral liberation consisting of chemical, hydraulic, and mechanical dispersion of a mineral slurry system.

Another embodiment comprises processing halloysite exploiting the unique physical and chemical characteristics of the mineral halloysite.

Another embodiment comprises specifically increasing and expanding a relative density differential value of halloysite.

Another embodiment comprises the separating process comprising a wet processing method comprising a step of utilizing and optimizing/maximizing intrinsic buoyance forces (Fb) of halloysite.

Another embodiment comprises optimizing the intrinsic Fb of halloysite for buoyancy enhancements via chemical and thermal treatments to remove inter-lumen water to adjust dynamics of halloysite buoyancy and density axioms in fluid mediums.

Another embodiment comprises the concentration and separation processes comprising specifically designed mechanical and hydraulic reactors, classifiers, and separation vessels with optimized operating parameters to transform composite mineral slurries into concentrated halloysite products with desired purity and quality on commercial scales.

Another embodiment comprises mechanical and hydraulic reactors and vessels that comprise:
a) modified simple agitated vessel/tank;
b) slurry inlet;
c) bottom outlet/discharge;
d) homogeneous mixing;
e) axial/radial flow agitation;
f) variable speed motor; and
g) side mounted variable height discharge valves for slurry reactors and vessels and/or overflow discharge for “thickener” type vessel systems.

Another embodiment comprises mechanical and hydraulic reactors and vessels that utilize both static and dynamic separation principals.

Another embodiment comprises a time of separation that is relative and a function of a slurry depth.

Another embodiment comprises a production of a halloysite product with desired quality and purity based on separation dynamics of buoyancy, drag, and gravitation forces.

Another embodiment comprises one optimized operating parameter of a Maximum Slurry Column Height for efficient separation and concentration being a minimum of 12″-16″ and maximum slurry column height of 40′-50′ as defined by slurry solids, purity desires, and production required.

Another embodiment comprises another optimized operating parameter of an operating solids being at 3%-50%.

Another embodiment comprises classifiers that are accelerated gravity centrifuges utilizing and separating based on relative density and particle morphologies of the mineral slurry systems.

Another embodiment comprises selective quality measures of particle size distribution using modified Stokes' Law and X-rays to determine halloysite concentration and impurity removal success.

Another embodiment significantly increases the commercial global quantities and volumes of halloysite from low-grade halloysite deposits.

Another embodiment significantly increases the commercial global quantities and volumes of halloysite from low-grade halloysite deposits.

Another embodiment is a halloysite product with desired quality, purity, consistency, and homogeneity on commercial scales produced by a system for processing halloysite from primary and/or secondary global mineral deposits, comprising liberating, separating and concentrating processes.

Another embodiment is a halloysite product with enhanced purity and color/brightness obtained by magnetic separation and/or leaching/bleaching.

Another embodiment is a halloysite product that has improved and consistent particle morphology for enhancing product performance and value.

### BRIEF DESCRIPTION OF THE DRAWINGS

Many aspects of the present disclosure can be better understood with reference to the drawings presented herein and/or in Appendix I and Appendix II, the contents of which are incorporated by reference herewith. The components in the drawings are not necessarily to scale, emphasis instead being placed upon clearly illustrating the principles of the present disclosure. Moreover, in the drawings, like reference numerals designate corresponding parts throughout the several views.

Additional advantages of the present disclosure will be set forth in part in the description which follows, and in part will be obvious from the description, or can be learned by practice of the present disclosure. The advantages of the present disclosure will be realized and attained by means of the elements and combinations particularly pointed out in the appended claims. It is to be understood that both the foregoing general description and the following detailed description are exemplary and explanatory only and are not restrictive of the invention, as claimed.

FIG. 1 provides an illustrative diagram of a general methodology for a weathered granodiorite processing.

FIG. 2 provides an illustrative diagram of a generalized crushing processing for crushing a ROM ore stockpile.

FIG. 3 provides an illustrative diagram of a quartz and feldspar co-product circuit/flow sheet.

FIG. 4 provides an illustrative diagram of a coarser K-feldspar circuit/products removed during initial classification of resource material.

FIG. 5 provides an illustrative diagram of a quartz co-product circuit, coarse product from initial classification.

FIG. 6 provides an illustrative diagram of a finer classification circuit including halloysite clays.

FIG. 7 provides an illustrative diagram of a final kaolin-halloysite separation circuit and products.

FIG. 8 illustrates the reactor with structures.

FIG. 9 provides a schematic flow diagram that illustrates the exemplary method for the experiments descripted, as well as the secondary trials run during the experiment.

FIG. 10 represents results of the various classification and concentration scenarios.

FIG. 11 represents Sedigraph particle size distribution profiles as a function of classification processes.

FIG. 12 is a hydroclone feed individual graph from FIG. 11.

FIG. 13 is a hydroclone overflow individual graph from FIG. 11.

FIGS. 14A-B are a 1^{st} pass 40% Cut Product individual graphs from FIG. 11.

FIG. 15 is a 1^{st} pass 50% Cut Product individual graph from FIG. 11.

FIG. 16 shows the data of 1^{st} pass 35%, Mass Frequency vs. Diameter.

FIG. 17 presents an imagine of 1st pass 35% Fine Product, Dry, 800×.

FIG. 18 presents an imagine of 1st pass 35% Fine Product, Wet, 800×.

FIG. 19 presents an imagine of 1^{st} pass 35% Fine Product, Wet, 2000×.

FIG. 20 represents an imagine of 1st pass 35% Fine Product, Wet, 10000×.

FIG. 21 shows the data of 2nd pass 50%, Mass Frequency vs. Diameter.

FIG. 22 presents an imagine of 2nd pass 50% Fine Product, Dry, 800×.

FIG. 23 presents an imagine of 2nd pass 50% Fine Product, Wet, 800×.

FIG. 24 presents an imagine of 2nd pass 50% Coarse Product, Wet, 2000×.

FIG. 25 presents an imagine of 2nd pass 50% Coarse Product, Wet, 6000×.

FIG. 26 shows the data of single pass 50%, Mass Frequency vs Diameter.

FIG. 27 presents an imagine of single pass 50% Fine Product, Dry, 2000×.

FIG. 28 presents an imagine of single pass 50% Fine Product, Wet, 800×.

FIG. 29 presents an imagine of single pass 50% Cut Product, Wet, 2000×.

FIG. 30 presents an imagine of single pass 50% Cut Product, Wet, 10000×.

FIG. 31 presents an imagine of 35%/50% Pass Coarse Product, Dry, 800×.

FIG. 32 presents an imagine of 35%/50% Pass Coarse Product, Wet, 80.

FIG. 33 presents an imagine of 35%/50% Pass Fine Product, Wet, 2000×.

FIG. 34 presents an imagine of 35%/50% Pass Fine Product, Wet, 150000×.

FIG. 35 presents an imagine of 50% Pass Coarse Product, Dry, 800×.

FIG. 36 presents an imagine of 50% Pass Coarse Product, Wet, 800×.

FIG. 37 presents an imagine of 50% Pass Coarse Product, Wet, 2000×.

FIG. 38 presents an imagine of 50 Pass Coarse Product, Wet, 120000×.

FIG. 39 presents an imagine of Floated, Dry 800×.

FIG. 40 presents an imagine of Floated, Wet 800×.

FIG. 41 presents an imagine of Floated, Wet, 2000×.

FIG. 42 presents an imagine of Floated, Wet, 6000×.

FIG. 43 presents a diagram shown the process of obtaining a set of final halloysite products.

FIG. 44 provides summaries of the key brightness processing results and the product quality measures of the three products.

FIG. 45 illustrates the methodology as a flowsheet identifying each unit operation.

FIG. 46 illustrates the range and scope of the separation and concentration process.

FIG. 47 shows SEM results for centrifuging step and the differential flotation step.

FIG. 48 provides a crushing and clay/sand separation block flow diagram.

FIG. 49 provides a feldspathic sands and K-feldspar block flow diagram.

FIG. 50 provides a quartz block flow diagram.

FIG. 51 provides a kaolin/halloysite separation and kaolin block flow diagram.

FIG. 52 provides a halloysite block flow diagram.

FIG. 53 provides a tailings block flow diagram.

### DETAILED DESCRIPTION OF PREFERRED EMBODIMENTS

An exemplary embodiment of the present disclosure provides and teaches a system for and a method of (1) liberating, separating, and concentrating components of a natural or synthetic mineral resource matrix; (2) evaluating and sustainably producing a halloysite precursor product, of high purity, for the creation of various consumer products and commercial products; and (3) evaluating, measuring, testing, and quantifying the halloysite product, and the other valuable mineral components, in a natural, synthetic, or partially-processed mineral resource matrix.

Non-limiting examples of a natural mineral resource matrix include saprolitic rock, country-rock, weathered granodiorite, potassium feldspar, sodium feldspar, crude kaolin clay, partially-processed halloysite, and quartz ore. Numerous other natural mineral resource matrixes are envisioned to be within the scope of this disclosure. Non-limiting examples of a synthetic mineral resource matrix include exothermic processing waste streams derived from a paper mill sludge or deinking sludge, and carpet processing third streams. Numerous other synthetic mineral resource matrixes are envisioned within the scope of this disclosure.

In another exemplary embodiment, the system and method are configured to liberate, separate, and concentrate mineral halloysite to equal to or greater than about 90% purity levels. In particular, the system and method leverage an enhanced separation and concentration technique to improve the percent yield of the mineral halloysite final product. In certain embodiments, the separation and concentration technique take advantage of the (1) unique morphological and size characteristics, (2) particle size distribution (PSD), and (3) surface chemistry of the halloysite nanotubes when dispersed in a water-based slurry.

More specifically, in certain embodiments, the separation and concentration technique take advantage of the (1) aspect ratio, (2) particle morphology, (3) surface area, and (4) relative density of the halloysite nanotubes relative to a surrounding particle-fluid medium. In certain embodiments, the time of separation is relative and a function of the slurry depth. Production and quality and purity dictated if shallower vessels versus taller vessels provide the better product based on the separation dynamics of buoyancy, drag, and gravitational forces.

These distinctive characteristics provide for a system and method wherein the halloysite nanotubes are separated and concentrated using either gravity or centrifugal force, or both. The system and method yield improved separation and concentration kinetics and prove to be an efficient and effective pathway for concentrating halloysite nanoparticles in the fine fraction of a fluid dispersed mineral particle medium.

In another exemplary embodiment, the system comprises a special purpose reactor configured to efficiently, effectively, and economically liberate, separate, and concentrate a halloysite from a resource matrix to a relatively high purity level without chemical change to the halloysite. The system may be configured to facilitate processing and extraction of the halloysite component as well as the other clay minerals, silicates, and/or nano-material components present within the matrix, as either a batch or continuous type system. In certain embodiments, the system critical components such as an agitator (although the reactor may operate in static mode and still achieve separation and concentration) and a reactor vessel designed with variable-height discharge outlets. In certain embodiments, the reactor may be similar in configuration to a slow rake paper pulp processing reactor or a clarifier.

The system also may comprise a scanning electron microscope, a transmission electron microscope, an energy dispersive spectroscopy instrument, and/or a laser or x-ray Sedigraph subsystem, such as that produced by Micrometrics™, to provide analytical data related to the (1) particle size, (2) relative particle-size distribution (PSD), (3) mass frequency function, (4) component ratio, and (5) actual-volume quantification of the components within the crude matrix analyte, or partially processed matrix analyte.

In another exemplary embodiment, the method of the present disclosure is generally directed to evaluating, measuring, testing, and quantifying halloysite within a resource matrix. The method relies on analytical instruments such as those described herein as part of the general system or the special purpose reactor system. In certain embodiments, a Sedigraph sub-system is used to implement a sedimentation particle size technique, which leverages a modified Stokes law and Stokes/Einstein equation, to yield a “mass-frequency” particle size distribution model. The model is used to provide an objective technique for determining the component ratios of the fluid dispersed analyte. In this way, the Sedigraph determines particle size via an accurate and reproducible sedimentation technique and measures the gravity-induced settling rates of different size particles in the fluid medium with known properties. Similarly, a scanning electron microscope instrument associated with the method may take advantage of the fluid-dispersed processing described herein to yield a more objective determination of the component ratios in the analyte.

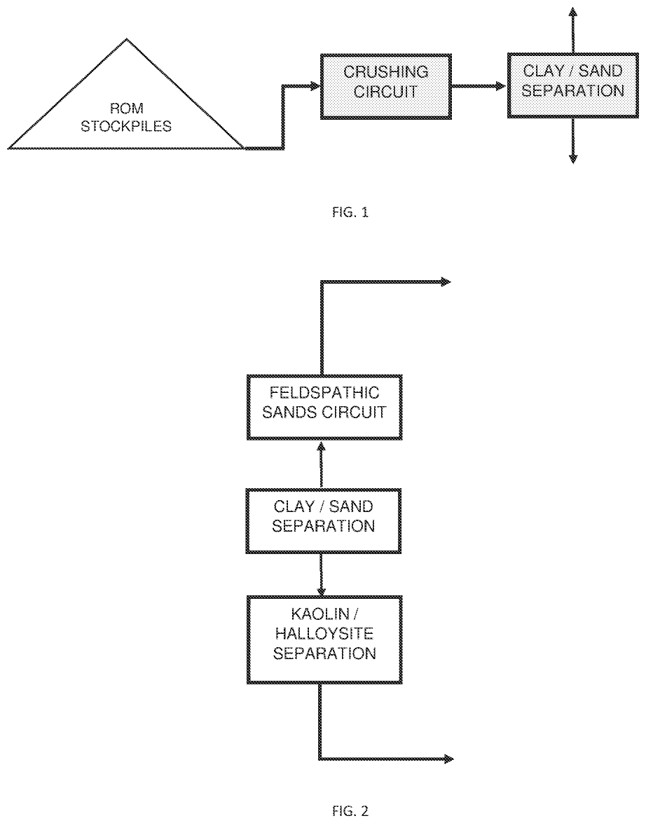

In another exemplary embodiment, dealing with weathered granodiorite processing, a method of the present disclosure comprises the generalized methodology illustrated in FIG. 1. The generalized methodology involves steps, not all of which are necessarily employed in each and every situation, but which may have similarities to other exemplary embodiments provided herein.

The primary input is a run-of-mine (ROM) ore stockpile excavated from a weathered granodiorite mineral resource matrix. The ore is a fine, white, non-sized clayey sand excavated without drilling, crushing, or blasting using contract miners, for example, via 3-cubic-yard excavators and 30-ton trucks. The ROM ore stockpile carries a relatively low initial mining cost as a primary input.

The ROM ore stockpile is crushed in a generalized crushing processing circuit, and then wet-screened to separate a sand fraction with particles greater than about 44 microns (μm), from a clay fraction with particles less than 44 μm, via a 325 mesh screen. (See FIG. 2)

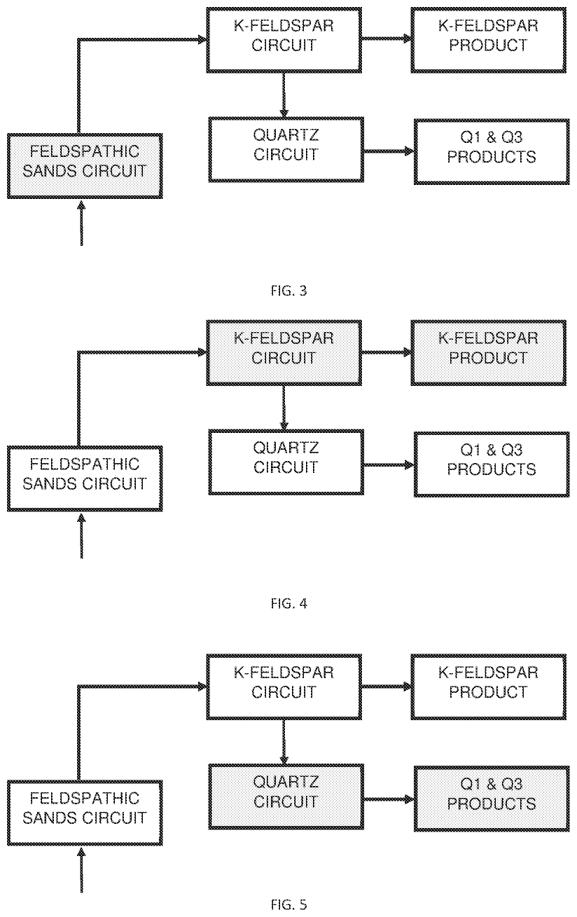

The sand fraction is primarily feldspathic sand, which subsequently enters a generalized feldspathic sands processing circuit (See FIG. 3 in which the Feldspathic Sands Circuit is highlighted), and the clay fraction is primarily a kaolin clay, which subsequently enters a secondary separation step.

With regard to the generalized feldspathic sands processing circuit, the partially processed resource matrix is further ground and run through a coarse screen ranging from 12-100 mesh in preparation for further processing. After the sand fraction is properly ground, the partially-processed matrix is further processed via attrition scrubbing (e.g., iron floating, etc.) and/or hydrocloned and floated (feldspar is floated, quartz is sunk), in order to separate the components that are less than 200 mesh. See FIG. 4 in which K-Feldspar Circuit and K-Feldspar Product are highlighted.

The resulting product is primarily potassium feldspar and an intermediate quartz product, which is intended to enter a generalized quartz processing circuit. The primary potassium feldspar enters a generalized potassium feldspar processing circuit comprising a drying step and then a magnetizing via rare earth magnets step. The processed primary feldspar ultimately becomes a sand-grind feldspar product, or one having a finer grind. See FIG. 5 in which the Quartz Circuit and Q1 and Q3 Products are highlighted.

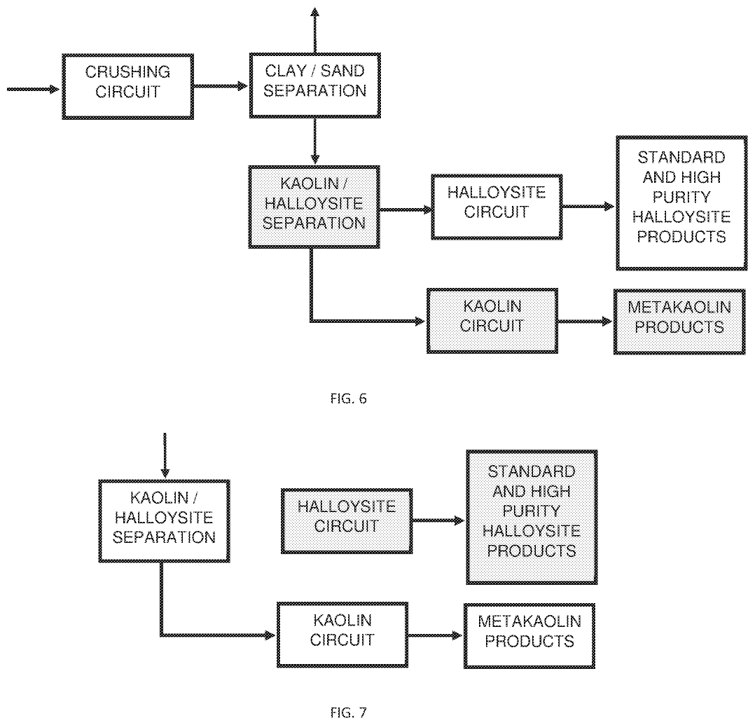

Similarly, the intermediate quartz product, intended to enter the quartz processing circuit, ultimately becomes at least two finished quartz products of relatively high purity. The quartz sinks, from the basic flotation step, operate as the intermediate quartz product. The quartz sinks enter a generalized quartz processing circuit comprising a grinding the quartz to less than about 50 mesh step, then at least three rounds of flotation, and then a magnetizing via rare earth magnets step. The processed quartz ultimately becomes a relatively pure quartz product containing about 300 ppm or less of non-silicon oxide contaminants. See FIG. 6.

Returning to the second processing path, stemming off of the ROM wet-screening step and leading into the secondary separation step, the kaolin clay fraction primarily is a kaolinite and halloysite composite. The secondary separation step comprises hydrocloning the clay mineral slurry to divide the coarse fraction that is greater than 20 microns (μm), from what made it through the 325 mesh. The coarse fraction is redirected to a tailings processing pathway as underflow (not illustrated), and the remainder is centrifuged into separate fractions, roughly delineated by those particles that are less than 20 μm but are as a whole are primarily kaolinite and halloysite. The resulting fractions are an intermediate kaolinite product, intended to enter a generalized kaolin processing circuit, and an intermediate halloysite/kaolinite composite (about 70/30 in ratio) intended to enter a generalized halloysite processing circuit. See FIG. 7.

In the kaolin circuit, the intermediate kaolinite product is at least calcined to about 700° C. in the kaolin processing circuit to ultimately become a relatively pure metakaolin. The intermediate halloysite product is fluid dispersed with a dispersing agent (sodium polyacrylate, water, or alcohol, for example) and at least processed in the halloysite processing circuit with an accelerated gravity method (using a solid bowl centrifuge, for example) and/or a differential flotation step (i.e., gravity separation by settling) (described in greater detail herein) in a differential flotation reactor. The differential flotation reactor may be configured as a batch or continuous operation system employing both a dynamic/active separation phase and/or a static/passive flotation phase.

The resulting product has the kaolinite concentrated in the denser fraction (considered coarser) and the halloysite concentrated in the less dense fraction (considered finer). The resulting product is then filter pressed and dried using conventional techniques to preserve the tubular morphology of the halloysite.

The resulting halloysite product ultimately becomes at least two finished halloysite products of relatively high purity, with at least one being of at least about 90% purity, and characterized by an exceptional aspect ratio, low toxic metal content, an optimized brightness, and no deleterious minerals (e.g., cristobalite, asbestiform minerals). No leaching is necessary in the halloysite processing circuit although it can be performed, as well as magnetic separation, and bleaching, for example. The finished halloysite product may be specifically designed and prepared, via control of the necessary methodology, and the necessary equipment and system, to function as a unique morphological capture platform, either in the form of a collector or collection/precipitation agent. The finished halloysite product exhibits unique structural properties, including a tunable release rate and a fast adsorption rate. A consumer product derived from the finished halloysite product may have a secondary or tertiary, etc. component(s) and/or active ingredient(s) embedded within.

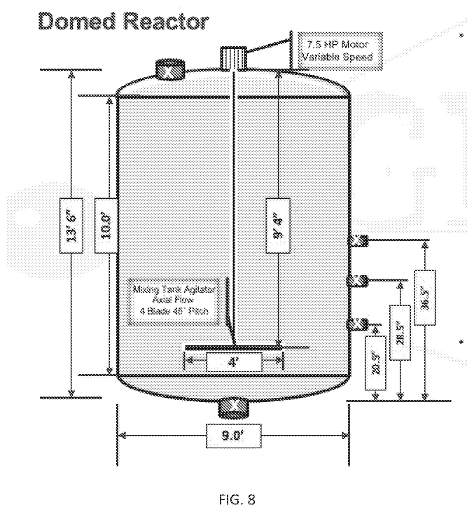

In another exemplary embodiment, dealing with the halloysite processing circuit and the differential flotation step, the method of the present disclosure is facilitated at least in part by a special purpose reactor having the generalized structure illustrated in FIG. 8.

The generalized structure may be applicable to the exemplary embodiments of the present disclosure described herein. The diagram of the generalized structure illustrates embodiments of relevant sub-systems and equipment, not all of which are necessarily employed in each and every situation, but which can have similarities to other exemplary embodiments referenced herein.

The reactor is a modified simple agitation tank but can be run in static mode. The reactor is domed and structured from 316 L stainless-steal walls defining a cylindrical reactor vessel and comprising a mixing tank agitator at the bottom, with 45 degree pitch blades, communicatively and operatively coupled to a 7.5 horse-power variable speed motor at the top, via a longitudinal vertical drive shaft/axle. The mixing tank agitator and the motor provides for homogenous mixing, via axial flow agitation, of the intermediate halloysite slurry column housed within the reactor.

The reactor has an about 12-inch top inlet for input of the intermediate halloysite product, and an about 4-inch bottom outlet/discharge. Along the walls defining the cylindrical reactor vessel, the reactor also has about 4-inch variable-height discharge outlets/valves for precise removal of the separated fractions and/or sampling of the slurry column within the reactor. The reactor dimensions, structure, and configuration of the reactor is such that the maximum slurry column height, for the most efficient separation and concentration, is between about 12 feet to about 16 feet for operating solids at between about 10% to about 30% in the slurry but may be less for other percentages of operating solids in the slurry, and such that the width is a ratio of about 1.5:1.

In this way, the special purpose reactor is configured to efficiently, effectively, and economically liberate, separate, and concentrate the halloysite, to a relatively high purity level, from the intermediate halloysite slurry column. The reactor also is configured to facilitate processing and extraction of the halloysite component as well as the remaining kaolinite present within the matrix. The reactor is envisioned to operate in both batch and continuous modes of operation. Further, in the situation where a mineral resource matrix is not kaolin clay or halloysite related, and where the matrix consists of any target fraction that is chemically identical to another fraction, but wherein the target fraction exhibits a difference in specific gravity due to physical characteristics and/or morphology, relative to the other fraction (such as happens to be the case with kaolinite and halloysite), the special purpose reactor is so configured to efficiently, effectively, and economically liberate, separate, and concentrate that non-halloysite target fraction to a relatively high purity level. In this way, the concepts extend beyond halloysite recovery.

This disclosure additionally includes the following documents, each of which is incorporated by reference herewith in its entirety:
Appendix I: GMT Halloysite Presentation.
Appendix II: HSK Experimental Summary

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Certain examples are presented in Appendix I and II, the contents of each of which are incorporated by reference herewith.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

For a further understanding of the nature, function, and object of the present disclosure, and the other embodiments described herein, reference is made to the following experimental results taken in conjunction with the accompanying tables, graphs, and/or drawings. While experimental results are provided herein, as well as the best mode of carrying out and employed in the experiment, these are not intended to be limiting.

### Experimental Results

This illustrative experiment comprises an exemplary embodiment of the method of the present disclosure, specifically performed for the purpose of optimizing and refining the inventive concept.

### Experiment 1

This experiment was performed to optimize the concentration and brightness of halloysite as a final processing product. The experiment also was performed to produce a metakaolin product from the kaolin fraction developed during processing of the raw material and concentration of the halloysite.

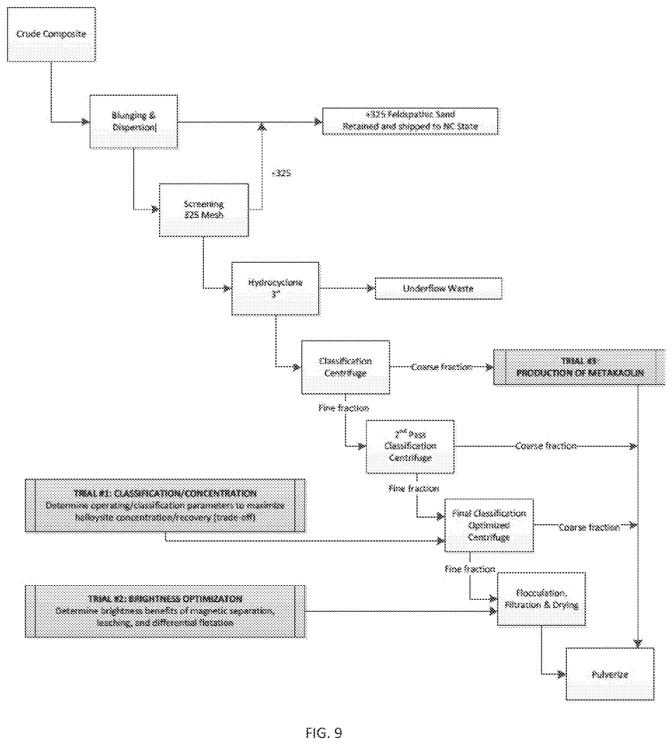

FIG. 9 provides a schematic flow diagram that illustrates the exemplary method followed by this experiment, as well as the secondary trials run during the experiment.

The experiment comprised processing about 12,744 pounds of bulk crude composite kaolin ore, as the primary input, via a pilot processing plant comprising an exemplary embodiment of a special purpose differential flotation reactor. The North American crude composite was crushed, via a generalized crushing process, and then placed in ten super-sacks and transported on pallets to the pilot processing plant.

Once at the pilot processing plant, about 12,159 pounds of the crude wet composite were blunged and dispersed to form a fluid dispersed mineral slurry. Once the blunging and dispersion step was complete, sand began settling off of the resulting mineral slurry. The remaining fluid dispersed mineral slurry was then wet-screened with a 325 mesh to further separate sand (a feldspathic sand fraction) from a kaolin clay fraction.

After the screening step, the settled sand and the oversized feldspathic sand fraction, which consisted primarily of quartz sand, feldspar, mica, etc., and which were about 78% of the total initial material, were placed into nine 55-gallon drums and shipped on pallets to a separate processing plant for feldspathic sand processing.

After the screening and primary separation step, the remaining kaolin clay slurry entered a secondary separation phase. More specifically, the kaolin clay slurry that made it through the 325 mesh was processed via a 3-inch hydroclone. The hydrocloning divided the coarse underflow waste from a finer remaining overflow slurry. The coarse underflow waste, which was about 3% of the kaolin clay slurry, and which was highly discolored, was discarded without having to go through a tailings processing pathway. The finer remainder overflow slurry was characterized as an about 25% solids slurry.

After the hydroclone step, the finer overflow slurry, which was about 97% of the kaolin clay slurry, was pumped into and stored in a 5,000 gallon tank for mixing and homogeneity. The finer overflow slurry functioned as the feed material for various classification and halloysite concentration studies. More specifically, the kaolin clay slurry was sampled from the tank and processed with various classification and concentration scenarios, via a solid bowl centrifuge, in some instances, or the special purpose reactor, in other instances, in order to determine the operating parameters that maximize the halloysite concentration, i.e., recovery or trade-offs. The various recoveries, particle-size fractions, yields, etc. of the various concentration scenarios were functions of processing solids, flow-rates, pool-depths, etc.

The various classification and concentration scenarios, with certain overarching conclusions, are outlined as follows:
1. Processed a tote volume through the centrifuge via conventional methods. This process removed 30% of the coarser material from the fraction.
2. Processed the overflow from 1. above in a second pass. This step removed a second 30% of the coarser material.
3. Processed a tote volume through the centrifuge with a primary removal of 40% of the coarse material.
4. Processed a tote volume through the centrifuge with a primary removal of 50% of the coarse material.
5. This concentration focused on the relative densities and morphology of the halloysite for separation and concentration. The “differential flotation” process uses air bubbles and air pockets as the separation mechanism and a special purpose reactor.

Each one of the concentration scenarios was executed and processed using the equivalent of a 300 gallon tote volume, and the mineral components were dispersed and liberated with sodium polyacrylate. Specific gravity (sg) was the critical parameter in determining the amount of fine and coarse fraction ratios. Classification variables such as flow rates, pond depth, rotational speed, etc. were used to change the specific gravities.

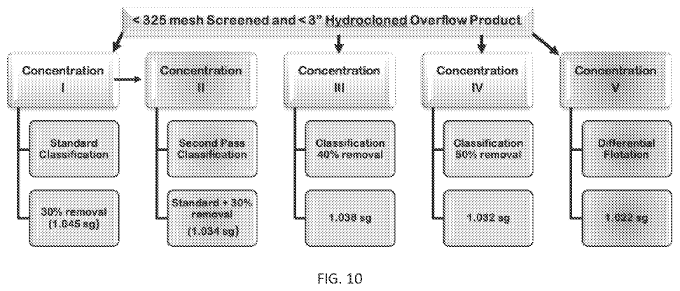

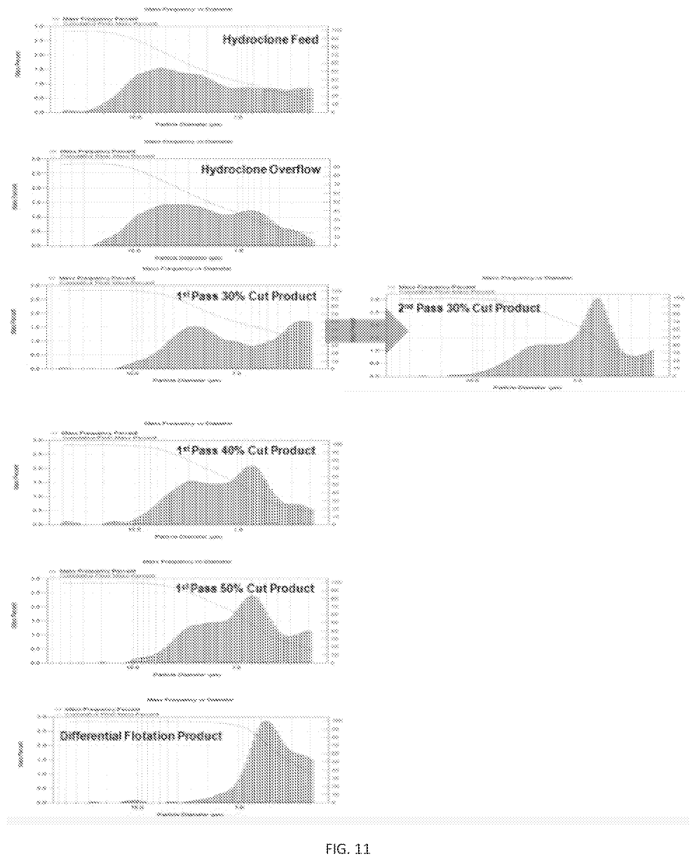

Results of the various classification and concentration scenarios are shown in FIG. 10. Summaries of key processing and final-product qualities resulting from the experiment, up through performance of the various classification and concentration scenarios, are as follows:

| | | PROCESS | YIELD FROM | PARTICLE | PARTICLE | TAPPI/GE |
|---|---|---|---|---|---|---|
| PROCESS FLOW | | RECOVERY/ | TOTAL DRY | SIZE | SIZE | BRIGHTNESS |
| DESCRIPTION | | YIELD | RESOURCE | @ 10 u | @ 2 u | % |
| +325 Screened Fraction | | 78% | 78% | | | |
| <325 Screened Fraction | | 22% | 22% | 88.8 | 49.9 | 63.00 |
| 3″ Hydroclone Overflow | | 90% | 19.8% | 87.9 | 50.8 | 64.43 |
| [symbol] Fraction | | | | | | |
| 50% Classification | Fine Fraction | 50% | 9.9% | 99.4 | 80.8 | 71.98 |
| Of Overflow | | | | | | |
| 50% Classification | Coarse Fraction | 50% | 9.9% | 85.4 | 24.8 | 52.12 |
| Of Overflow | | | | | | |
| 35%/50% Classification | Fine Fraction | 33% | 6.5% | 99.8 | 84.7 | 73.51 |
| Of Overflow | | | | | | |
| 35%/50% Classification | Coarse Fraction | 67% | 13.3% | 83.1 | 12.6 | 56.07 |
| Of Overflow | | | | | | |

| | | | | | |
|---|---|---|---|---|---|
| Differential Flotation from 50% | 71% | 7% | 98.9 | 98.3 | 75.72 |
| Classification Fine Fraction | | | | | |
| Of Overflow | | | | | |

[symbol]

indicates data missing or illegible when filed

After performance of the various classification and concentration scenarios, scanning electron microscope (SEM) image analysis and particle size evaluations, via the mass frequency function on a Sedigraph, were performed on the classified samples in order to determine the classification and concentration impact of each scenario. Most of the other testing was performed using American Society for Testing and Materials International (ASTM International™) standards and Technical Association of the Pulp and Paper Industry (TAPPI™) standards.

As most of the quantitative work for determining kaolinite and halloysite ratios usually depends on visual inspection, and as improvements to the field were sought, a wet dispersed SEM-sample preparation method also was used. The wet SEM preparation method allowed for a more objective visualization technique for determining and quantifying the ratios. Expanding the particle size evaluation to include mass frequency function analysis also offered improved outcomes.

More specifically, the Sedigraph is a sedimentation particle size analysis functioning off Stokes law and the Stokes/Einstein equation. For purposes of determining particle size fractions and mineral concentration of the classified samples, and how they interrelate, particle size measurements were performed, and mass frequency models were created to allow for the creation of mineral fractions as a function of the relative densities and the particle morphologies and/or aspect ratios, for example. These models allowed for an objective approach that yields a bi-modal distribution that can be inspected to confirm the separation and concentration of a specific fraction within a sample.

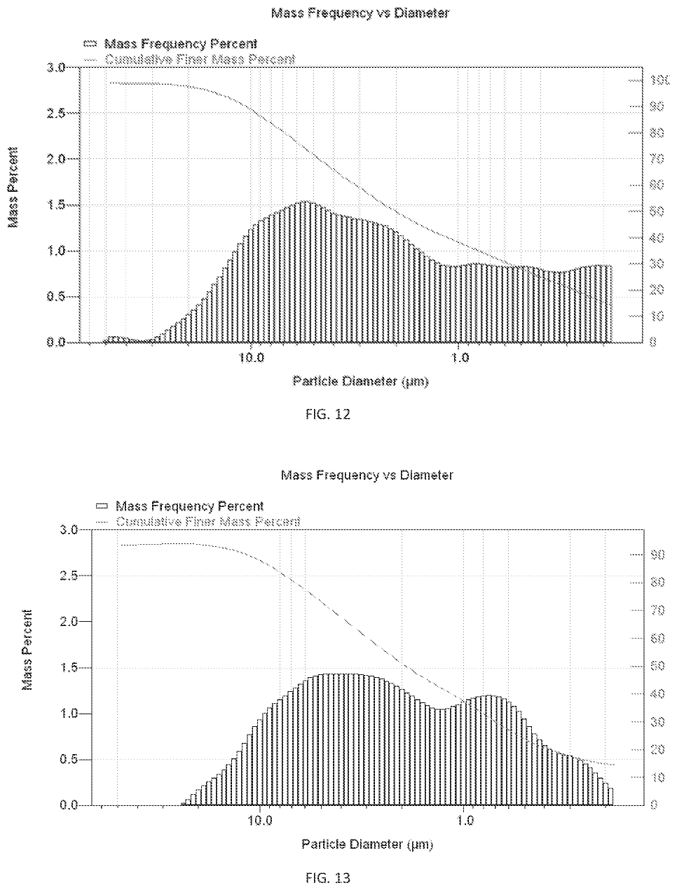

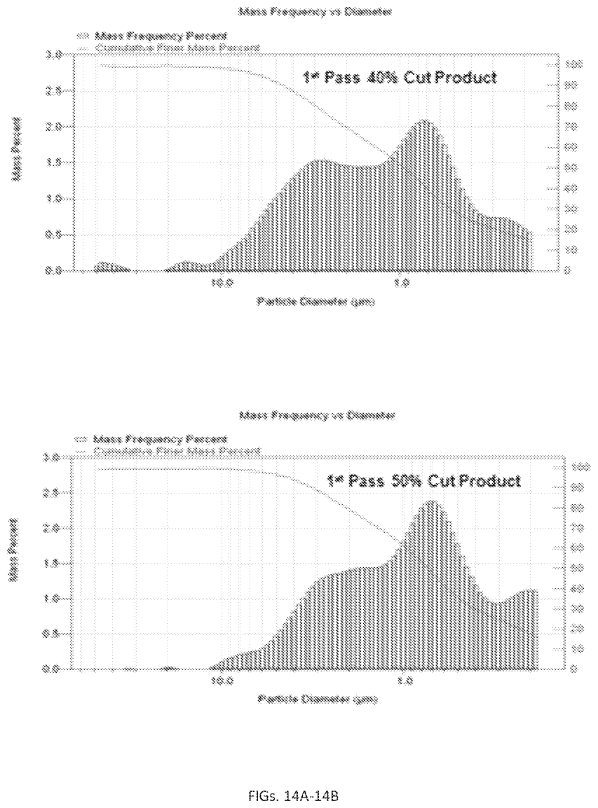

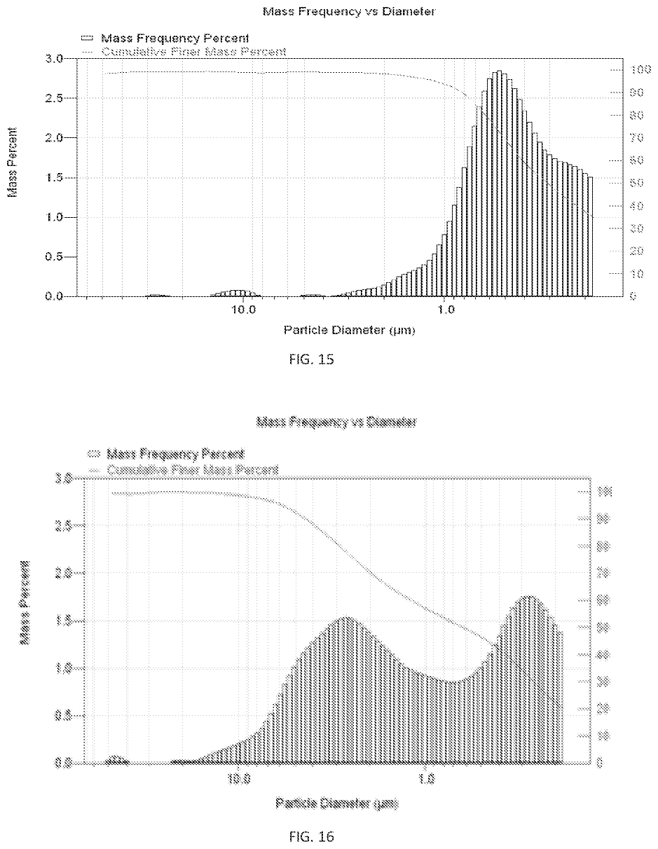

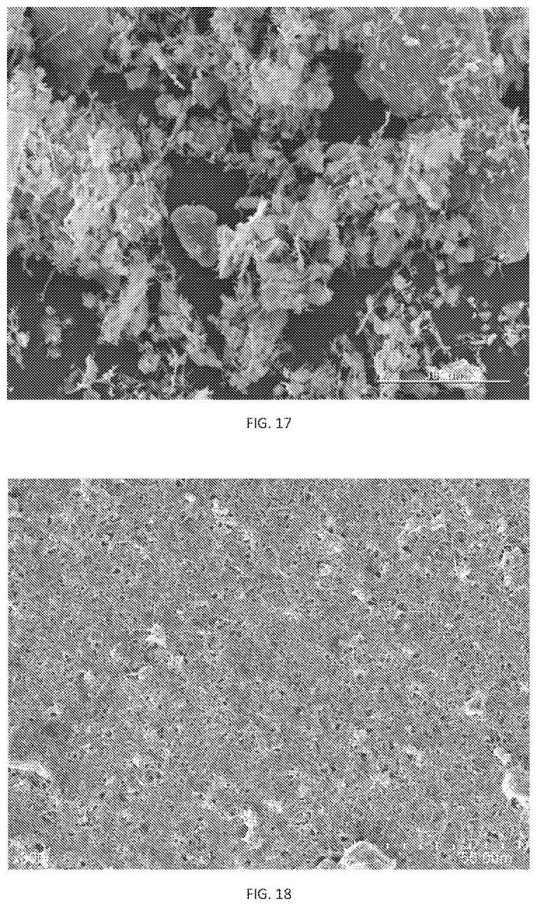

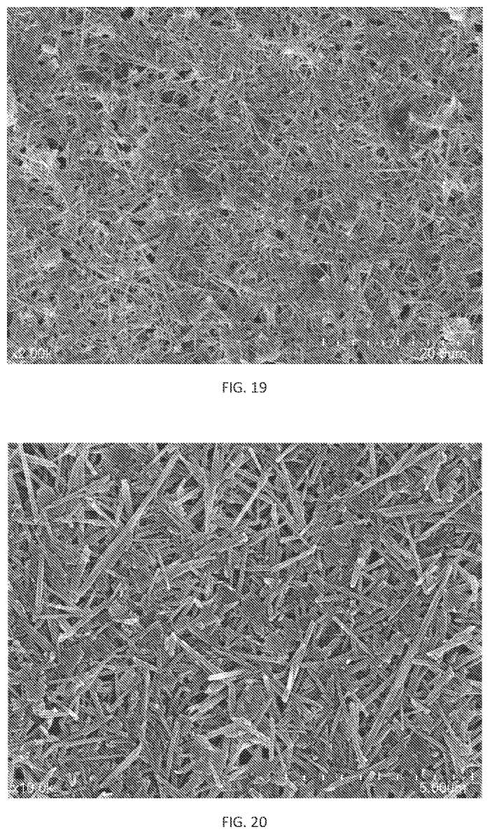

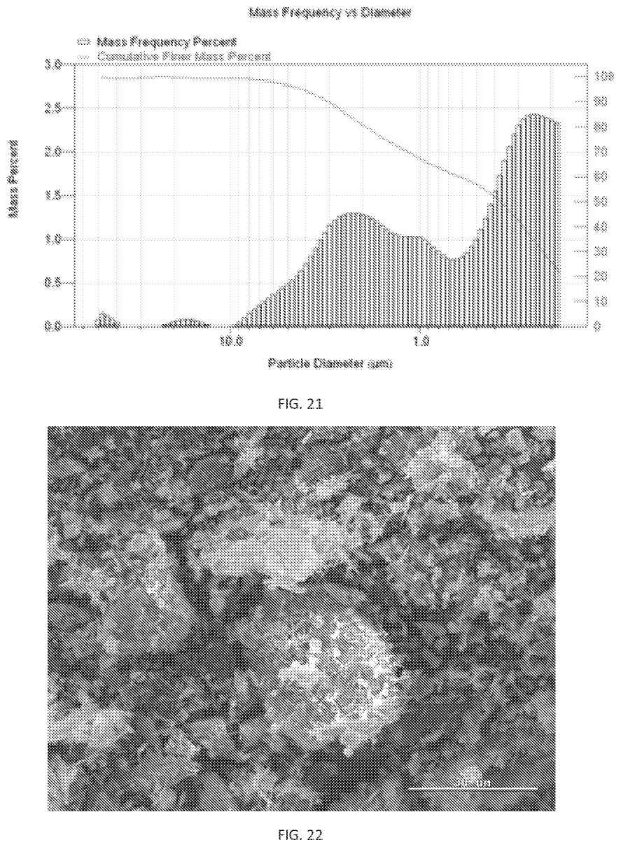

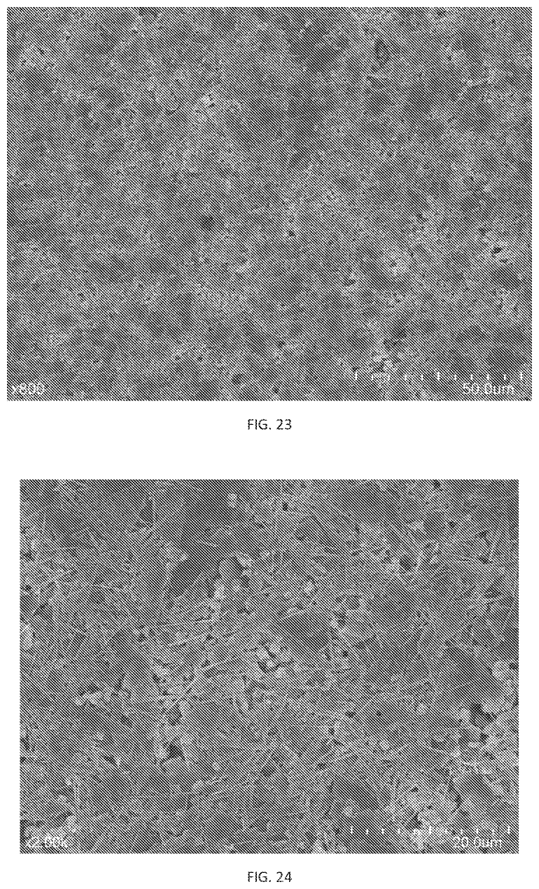

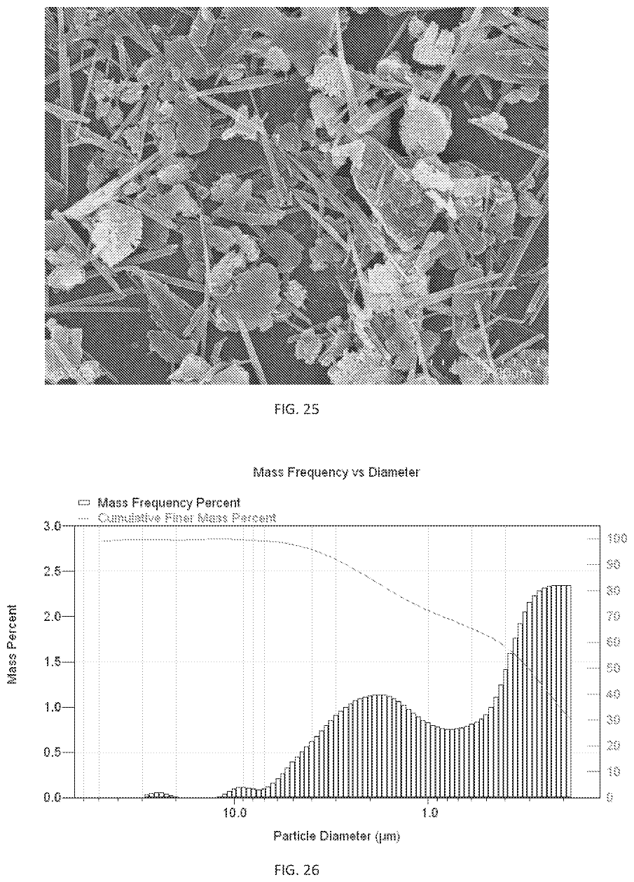

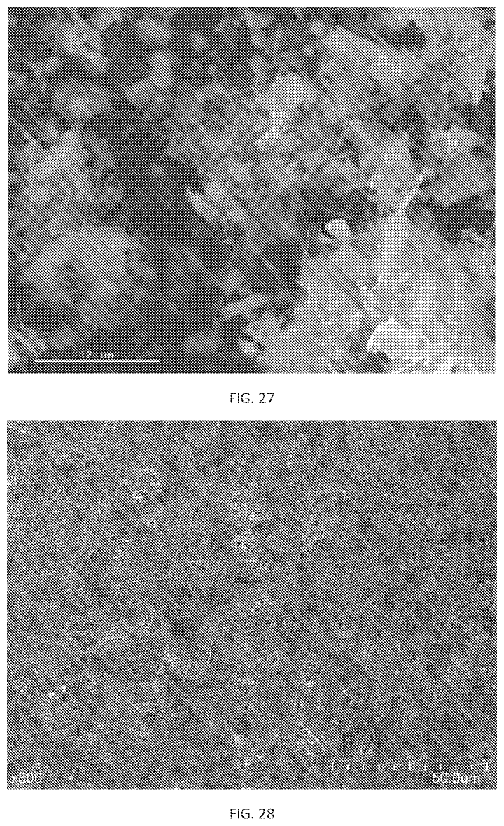

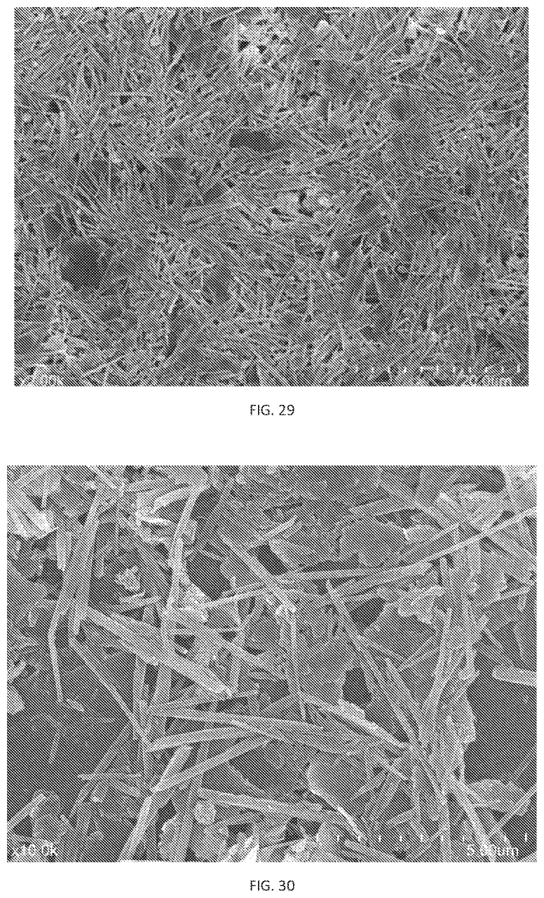

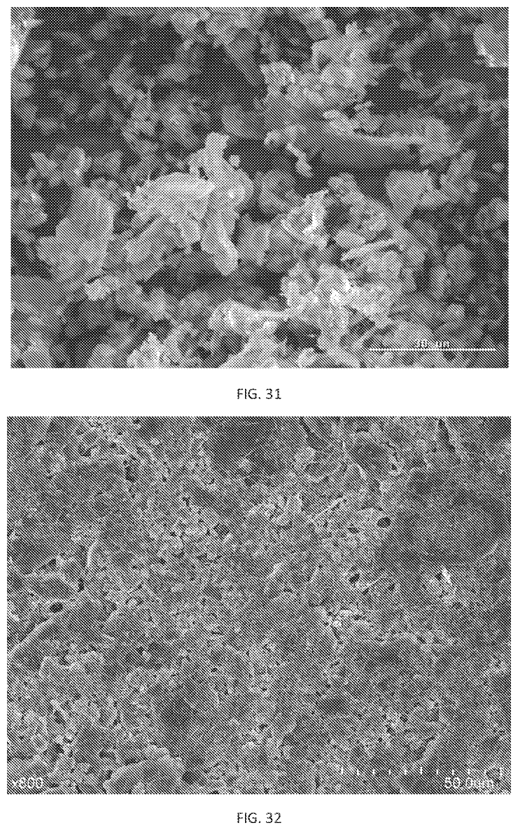

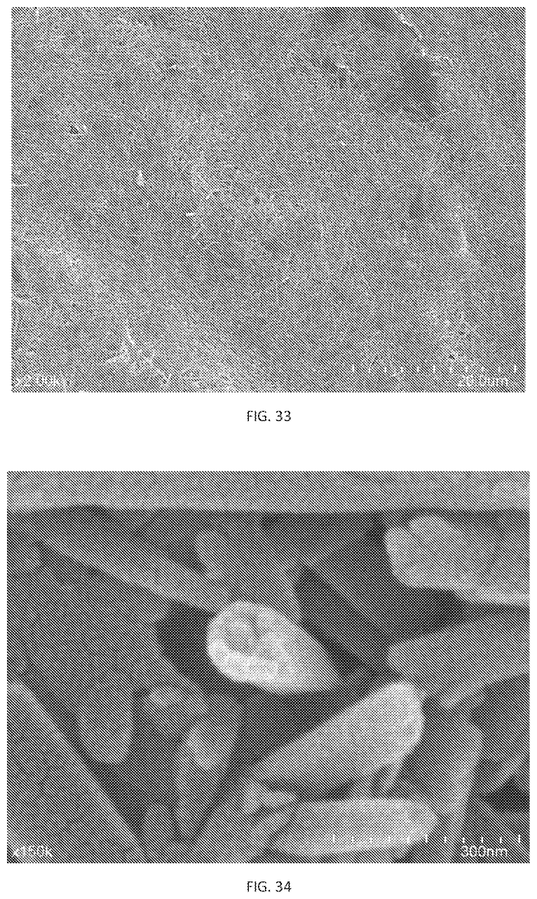

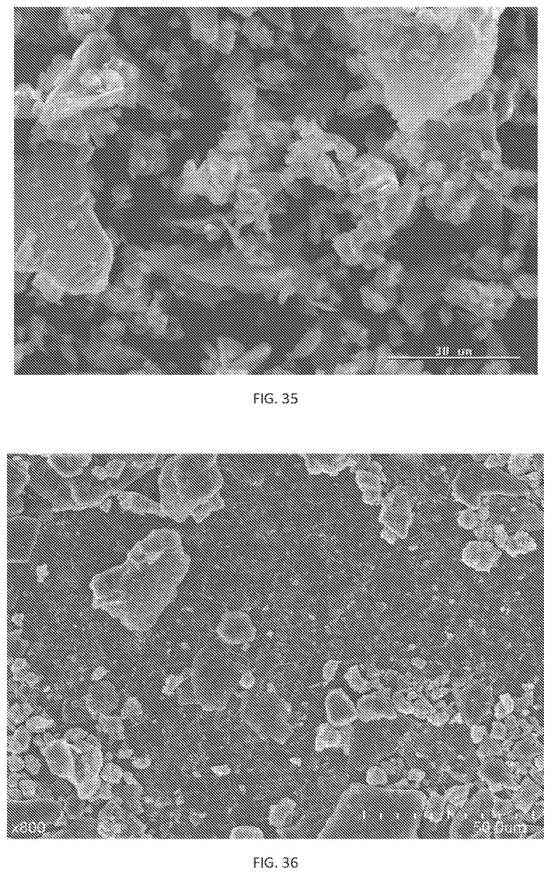

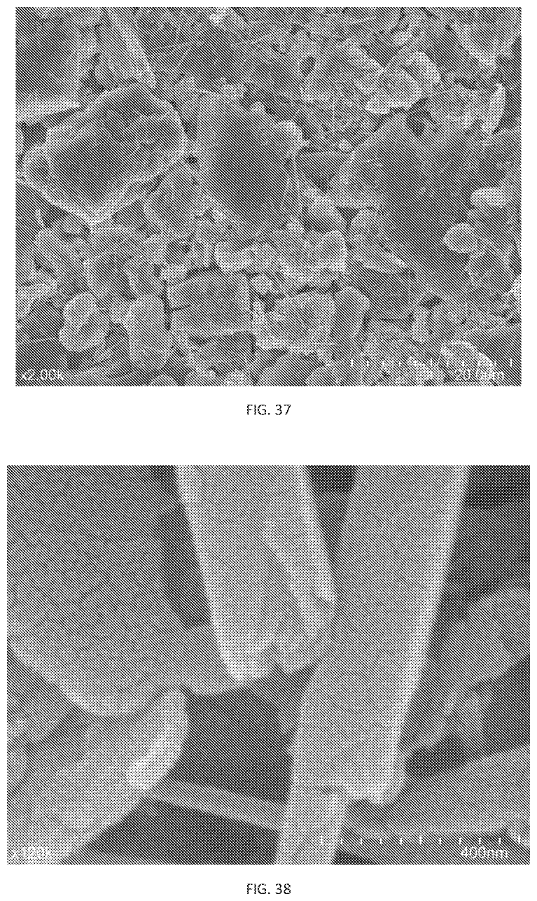

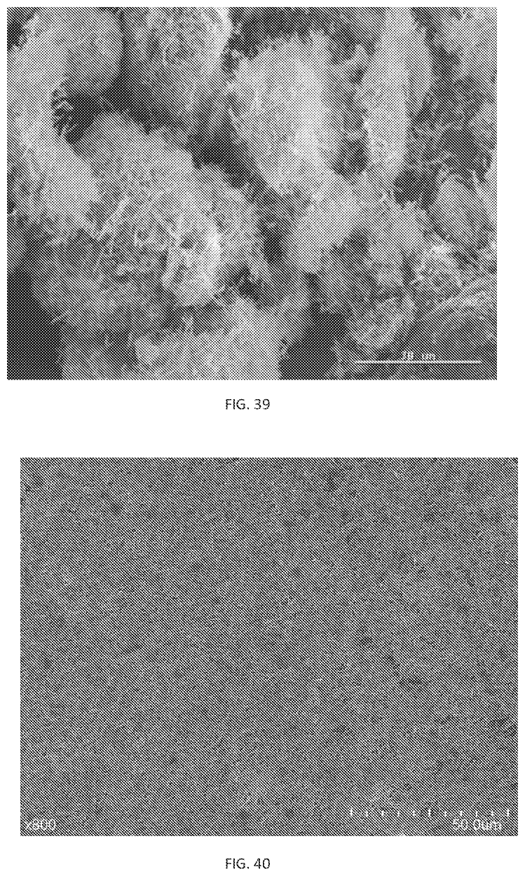

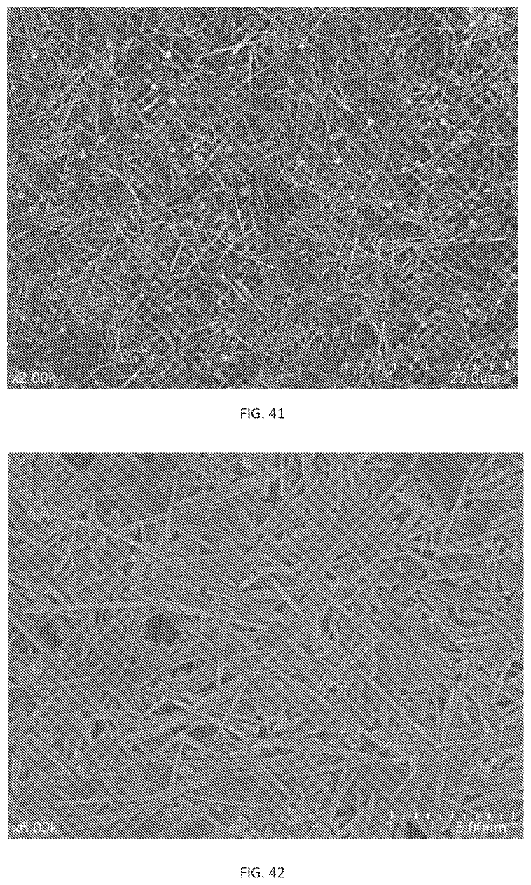

The SEM and particle size distribution graphs from the various classification and concentration scenarios are presented in FIGS. 11-15. FIGS. 16-30 show further results for a 35% cut product with second pass 50% cut product vs single pass 50% cut product. Further results for 35%/50% cut course and fine product are shown in FIGS. 31-42.

As predicted, the results of the various classification and concentration scenarios yielded a bimodal distribution with two distinct fractions; either a coarse kaolinite fraction (the left population; denser) or a finer halloysite fraction (the right population; less dense). The SEM images confirmed that the separation and concentration of the halloysite was in the finer fraction. Based on the results of the various classification and concentration scenarios the following became clear:
1. In terms of aspect ratio, kaolinite has a low three dimensional aspect ratio and the halloysite has a very high two dimensional aspect ratio.
2. In terms of particle morphologies, the kaolinite is a medium to well crystallized hexagonal plate and the halloysite is a lenticular hollow tube.
3. In terms of surface area, the kaolinite has a lower surface area and the halloysite has a higher surface area.
4. In terms of relative densities, the kaolinite has a higher relative density and the halloysite has a lower relative density due to its specific particle structure with tubes containing air, high surface area, and unique morphology.

These distinctive characteristics provided the information needed to create a system and process to efficiently and effectively concentrate halloysite from kaolin clay using gravity and, if needed, centrifuges and accelerated gravity techniques as is understood in the art. The differential flotation step provided selective separation of the two clay minerals despite being known in the art as a much slower and subjective process when compared to the accelerated gravity techniques using solid bowl centrifuges. Further, the prior art teaches flocculating to lower the pH and cause agglomeration, and then dewatering/filtration to yield a final product, when wet-processing kaolin clay. The system and method of the present disclosure, with the differential flotation, are entirely antithetical to what is currently performed in the art, and approach solving the problems in the art from the perspective of greater dispersion and less agglomeration.

The differential flotation step also proved to be the most selective concentration process to yield the purest and highest quality halloysite product. The estimated concentration of the final halloysite product was about 90% or greater using differential flotation. Further, it was determined that equal spherical diameter (ESD) theories and functions had very little impact on the integrated measurements taken with the Sedigraph and the insights the Sedigraph analysis afforded.

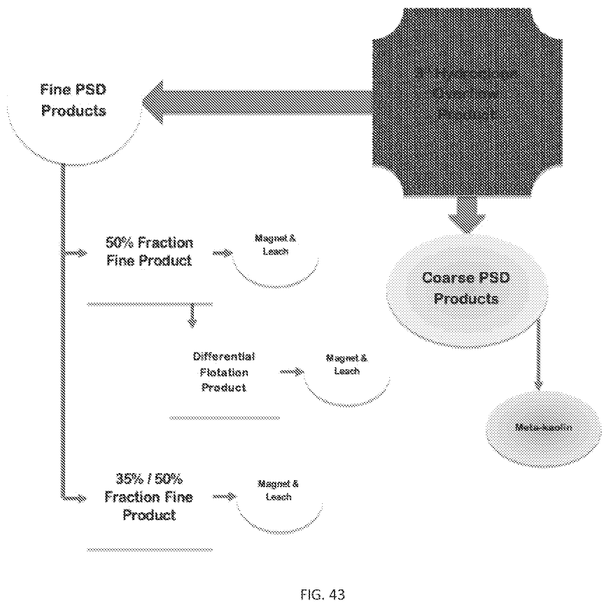

After completion of the various classification and concentration scenarios, a range of options for processing a final halloysite product were provided. A set of final halloysite products were then produced as illustrated in a diagram shown in FIG. 43.

The three primary fine fraction samples produced were defined as a 50% removal fine fraction product, a 35% first pass/50% second pass removal fine fraction product, and a differential flotation fine fraction product. All three primary fine fraction samples would be considered a high quality halloysite product as is understood in the art. The single pass 50% removal fine fraction product demonstrated the highest recovery, and the differential flotation fine fraction product had the purest and highest quality halloysite final product.

These three primary fine fraction samples were then used in order to determine the brightness benefits to the high purity halloysite from magnetic separation, leaching, and further differential flotation (the brightness optimization segment of the experiment), with emphasis on the concentrated halloysite fractions. Any superfluous course fraction was diverted for the production of meta-kaolin as a separate segment of the experiment.

More specifically, the brightness optimization segment of the experiment focused on the three products described above. Several brightness improvement processes were evaluated including leaching, bleaching, magnetic separation, selective separation, selective flocculation, and further differential flotation. A brightness leach ladder was used to demonstrate that the optimal brightness improved as a function of leach dosage, and that about 12 pounds per ton of sodium hydrosulfite was the optimal dosage for the highest brightness product. The three products also responded well to magnetic separation. The magnetic separation process utilized a medium matrix with a retention of about one minute. The low solids slurry was processed with the magnetic field strength set at about 2 tesla or about 20 kilogauss. Magnetic separation and leaching, therefore, were determined to be the most effective brightness improvement processes.

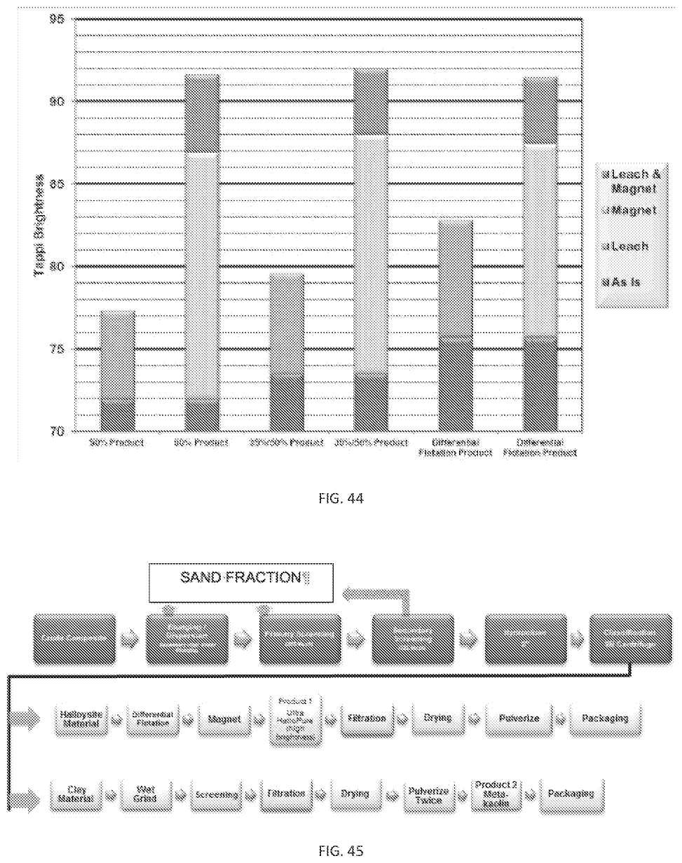

Product brightness improvements were about 20% or more, and some final processing products reached a 90% TAPPI or more brightness with both magnetic separation and leaching combined. The improvements were believed to be due to the removal of iron and titanium, as well as reduction of the oxidation state of any iron that might have been present. Summaries of the key brightness processing results and the product quality measures of the three products were presented in FIG. 44.

Summaries of the leach ladder brightness improvement processes and the magnetic separation brightness improvement processes are as follows:

35/50 Fines
PH of 3, 200 Mls at 12.67% Solids

| | Brightness | L | A | B |
|---|---|---|---|---|
| 0 lbs per ton ISO | 72.47 | 92.34 | 1.02 | 7.62 |
| 0 lbs per ton GE | 73.51 | 92.8 | 0.14 | 7.69 |
| 3 lbs per ton ISO | 75.49 | 93.41 | 0.84 | 6.96 |
| 3 lbs per ton GE | 76.57 | 93.84 | 0.04 | 7.01 |
| 6 lbs per ton ISO | 76.45 | 93.6 | 0.63 | 6.52 |
| 6 lbs per ton GE | 77.55 | 94.01 | −0.11 | 6.52 |
| 9 lbs per ton ISO | 77.5 | 93.77 | 0.53 | 5.95 |
| 9 lbs per ton GE | 78.61 | 94.16 | −0.1 | 5.94 |
| 12 lbs per ton ISO | 79.31 | 93.88 | 0.46 | 5.5 |
| 12 lbs per ton GE | 79.43 | 94.25 | −0.11 | 5.46 |
| 15 lbs per ton ISO | 78.46 | 93.89 | 0.45 | 5.38 |
| 15 lbs per ton GE | 79.59 | 94.26 | −0.1 | 5.34 |

50 Fines
PH of 3, 200 MLS at 15.67% Solids

| | Brightness | L | A | B |
|---|---|---|---|---|
| 0 lbs per ton ISO | 70.96 | 91.98 | 1.01 | 8.28 |
| 0 lbs per ton GE | 71.98 | 92.45 | −0.05 | 8.36 |
| 3 lbs per ton ISO | 73.06 | 92.75 | 0.84 | 7.84 |
| 3 lbs per ton GE | 74.12 | 93.2 | −0.07 | 7.9 |
| 6 lbs per ton ISO | 75.85 | 93.37 | 0.5 | 6.6 |
| 6 lbs per ton GE | 76.92 | 93.77 | −0.23 | 6.61 |
| 9 lbs per ton ISO | 75.7 | 93.21 | 0.49 | 6.46 |
| 9 lbs per ton GE | 76.78 | 93.62 | −0.22 | 6.46 |
| 12 lbs per ton ISO | 76.26 | 93.4 | 0.45 | 6.32 |
| 12 lbs per ton GE | 77.34 | 93.8 | −0.25 | 6.33 |
| 15 lbs per ton ISO | 75.46 | 93.13 | 0.49 | 6.51 |
| 15 lbs per ton GE | 76.54 | 93.54 | −0.24 | 6.51 |

Note:
Leach was at 13.00% solids

50 Float Fines
PH of 3, 200 MLS at 6.67 Solids

| | Brightness | L | A | B |
|---|---|---|---|---|
| 0 lbs per ton ISO | 74.64 | 93.09 | 0.97 | 7.1 |
| 0 lbs per ton GE | 75.72 | 93.53 | 0.16 | 7.15 |
| 3 lbs per ton ISO | 77.23 | 94.31 | 0.96 | 7.12 |
| 3 lbs per ton GE | 78.34 | 94.74 | 0.14 | 7.17 |
| 6 lbs per ton ISO | 78.23 | 94.45 | 0.8 | 6.57 |
| 6 lbs per ton GE | 79.35 | 94.87 | 0.06 | 6.59 |
| 9 lbs per ton ISO | 80.64 | 94.76 | 0.55 | 5.15 |
| 9 lbs per ton GE | 81.8 | 95.12 | 0.01 | 5.11 |
| 12 lbs per ton ISO | 81.41 | 94.78 | 0.48 | 4.58 |
| 12 lbs per ton GE | 82.58 | 95.12 | 0.03 | 4.53 |
| 15 lbs per ton ISO | 81.67 | 94.93 | 0.45 | 4.64 |
| 15 lbs per ton GE | 82.82 | 95.28 | −0.02 | 4.59 |

Magnet Run

| | Brightness | L | A | B |
|---|---|---|---|---|
| Float cut ISO | 86.2 | 96.49 | 0.33 | 3.87 |
| Float cut GE | 87.44 | 96.81 | −0.04 | 3.78 |
| 50 cut ISO | 85.72 | 96.51 | 0.39 | 4.28 |
| 50 cut GE | 86.93 | 96.84 | −0.04 | 4.21 |
| 35/50 cut ISO | 86.75 | 96.82 | 0.37 | 4.04 |
| 35/50 cut GE | 88 | 97.15 | −0.03 | 3.97 |

Magnet Run with Leach

| | Brightness | L | A | B |
|---|---|---|---|---|
| Float 10 lbs per ton ISO | 90.23 | 97.3 | 0.1 | 2.24 |
| Float 10 lbs per ton GE | 91.51 | 97.57 | −0.06 | 2.12 |
| 50 10 lbs per ton ISO | 90.38 | 97.47 | 0.08 | 2.45 |
| 50 10 lbs per ton GE | 91.67 | 97.74 | −0.09 | 2.32 |
| 35/5010 lbs per ton ISO | 90.74 | 97.59 | 0.09 | 2.41 |
| 35/50 10 lbs per ton GE | 92.04 | 97.86 | −0.06 | 2.26 |

Turning to the meta-kaolin processing segment of the experiment, the coarse fraction diverted for the production of meta-kaolin was dried and pulverized. The coarse kaolinite fraction, which contained a limited amount of halloysite remainder, was calcined to about 850° C. in an indirect rotary calciner to ultimately become a relatively pure metakaolin with pozzolanic applications and having a loss-on-ignition of about 0.5% at 1000° C.

In another exemplary embodiment, in light of the experimental results presented herein, a method of the present disclosure comprises the methodology illustrated in FIG. 45. The methodology involves steps, not all of which are necessarily employed in each and every situation, but which may have similarities to other exemplary embodiments provided herein.

The primary input is a crude composite comprising kaolin clay. The crushed crude composite is blunged and dispersed, via at least high shear blunging, to form a fluid dispersed mineral slurry, and then wet-screened with a 200 mesh screen to separate the feldspathic sand from the kaolin clay fraction remaining in the mineral slurry. A secondary wet-screening is performed with a 350 mesh screen to further remove leftover sand from the now primarily kaolin clay slurry.

The feldspathic sand fraction subsequently enters a feldspathic sands processing circuit such as those described herein. The kaolin clay fraction as a mineral slurry subsequently enters a secondary separation phase that begins with a hydrocloning step. It is not always necessary for a hydrocloning step to begin the secondary separation phase.

In this particular embodiment, the secondary separation phase comprises hydrocloning the current kaolin clay mineral slurry to divide the coarse underflow waste from the finer overflow slurry and then centrifuging the finer overflow slurry into separate fractions; one being an halloysite/kaolinite material (about 70/30 in ratio) intended to enter a halloysite processing path, and the other being the remaining kaolin clay slurry, which is primarily kaolinite with trace halloysite and which is intended to enter its own independent processing path.

Regarding the halloysite/kaolinite material path, the halloysite/kaolinite material is prepared for the differential flotation step via a special purpose reactor such as the exemplary embodiment described herein. In contrast to the other embodiments described herein, the halloysite/kaolinite material is first dried with temperatures in a range of about 100° C. to about 200° C., to further remove any residual free water or tube water that might remain in the internal space defined by the tubular morphology of the halloysite nanotubes. The dried halloysite/kaolinite material is thereby physically altered but not chemically altered to have a lower specific gravity in a fluid dispersed state than the surrounding medium.

The dried halloysite/kaolinite material is then fluid dispersed (with sodium polyacrylate, for example) and heated to a temperature in a range of about 45° C. to reduce the viscosity of the fluid medium without breaking down the dispersant(s) being used. The fluid dispersed material is then pumped into the special purpose reactor for the differential flotation step. The special purpose reactor first agitates the fluid dispersed material, with an emphasis on avoiding Brownian type motion, for about 30 minutes to about 1 hour, and then enters a static phase of about 24 hours to 60 hours (although, longer time frames may yield further separation and concentration) to allow for the differential flotation results.

The resulting product has the kaolinite concentrated in the denser coarser fraction and a very pure halloysite concentrated in the less dense finer fraction. The finer fraction is then removed by the unplugged discharge outlet as soon as it is determined where the fractions begin along the height of the special purpose reactor. The coarser fraction is left behind and flushed-out with water for processing in the remaining clay material path, for example. The finer fraction of halloysite is then run through a generalized magnetic separation step to produce a high brightness very pure halloysite product. The high brightness very pure halloysite product is then filter pressed and dried to preserve the tubular morphology of the halloysite.

This enhanced separation and concentration process with its two additional steps, i.e., the drying and fluid heating steps, yield about 20% to about 40% improved separation and concentration kinetics, and prove to be an even more efficient and effective pathway, for concentrating halloysite nanoparticles in a fine fraction, as compared to the other embodiments described herein. However, the enhanced separation and concentration process suffers from the drawback of requiring additional energy, which in turn implies additional costs, and the drawback of changing the heat, pressure, and other chemical conditions of the processing stream.

Whether the enhanced separation and concentration steps are implemented or not, the high brightness very pure halloysite product is at least about 90% purity, and characterized by an exceptional aspect ratio, low toxic metal content, an optimized brightness, and no deleterious minerals (e.g., cristobalite, asbestiform minerals). The finished halloysite product may be specifically designed and prepared, via control of the pulverization methods and packaging methods, for example, and the necessary equipment and system, to create a consumer product with a secondary or tertiary, etc. component(s) and/or active ingredient(s) embedded within.

With regard to the remaining clay material path, the kaolinite with trace halloysite is blunged, screened, filtered, calcined to about 700° C., and pulverized to ultimately become a relatively pure metakaolin. The denser coarse fraction concentrated with kaolinite from the halloysite/kaolinite material path may be redirected for processing into metakaolin as well.

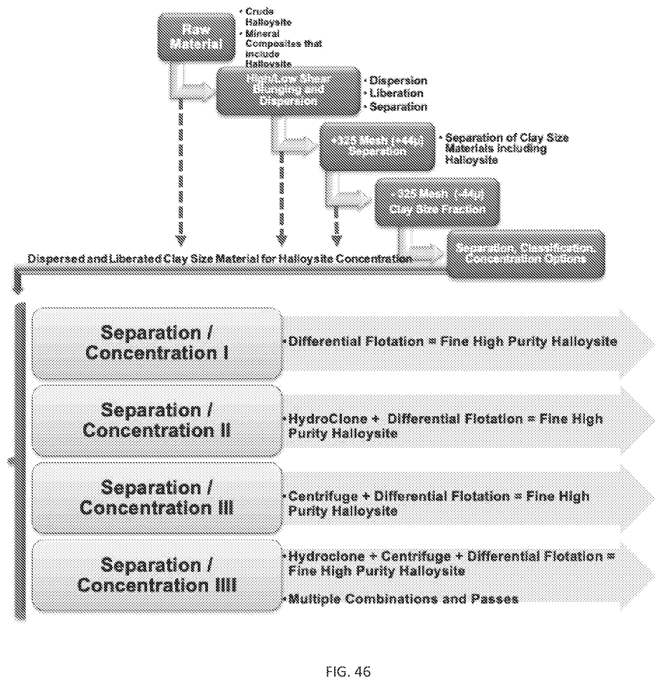

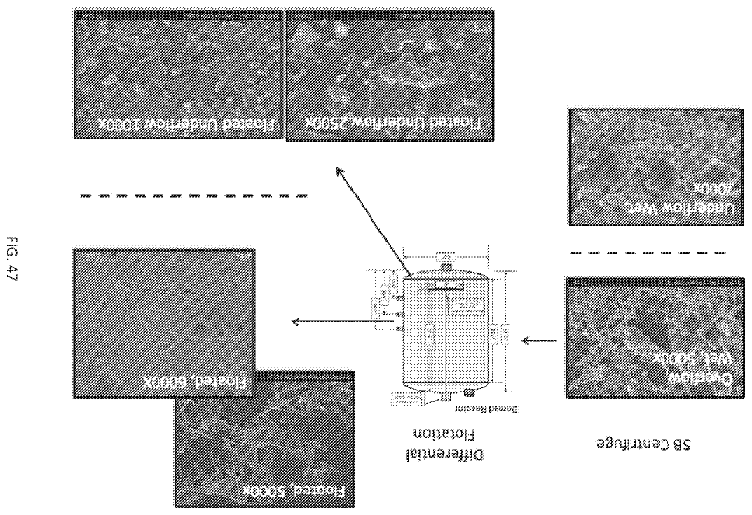

In another exemplary embodiment, a method of the present disclosure comprises the methodology illustrated in FIG. 46. The methodology involves steps, not all of which are necessarily employed in each and every situation, but which may have similarities to other exemplary embodiments provided herein.

The primary input is any crude halloysite or natural, synthetic, or waste stream mineral composite that includes halloysite. The crushed raw material is blunged and dispersed, via at least low shear and then secondary high shear blunging, to form a fluid dispersed slurry, and then wet-screened with a 325 mesh to separate out the clay-sized material including halloysite.

The primarily halloysite and other clay sized material slurry subsequently enters a secondary separation phase that varies depending on the nature of the raw material being processed by the method. It is possible that the secondary separation phase consists of a differential flotation step to a high purity halloysite product. It is possible that the secondary separation phase consists of a hydrocloning step, to divide the coarse underflow waste from a finer overflow slurry and then a differential flotation to yield a high purity halloysite product. It also is possible that the secondary separation phase consists of a hydrocloning step to divide a coarse underflow waste from a finer overflow slurry and then a centrifuging step, of the finer overflow slurry for additional refinement, and then processed via a differential flotation step to yield a high purity halloysite product.

In one illustrative experimental example, the secondary separation phase consisted of a centrifuging step, to separate a coarse wet underflow waste from a finer wet overflow slurry, and then a differential flotation, to yield a floated high purity halloysite product separate from a coarse kaolinite with minority halloysite underflow. SEM results for centrifuging step and the differential flotation step are illustrated in FIG. 47.

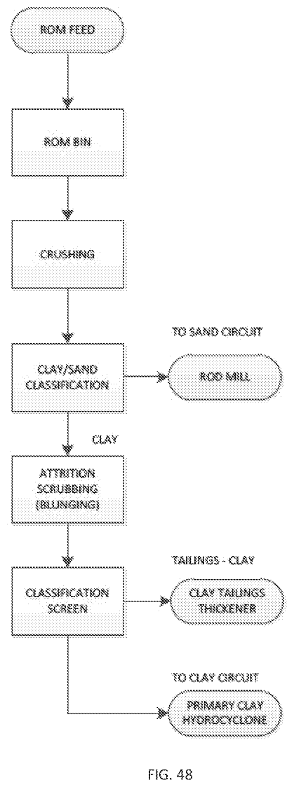

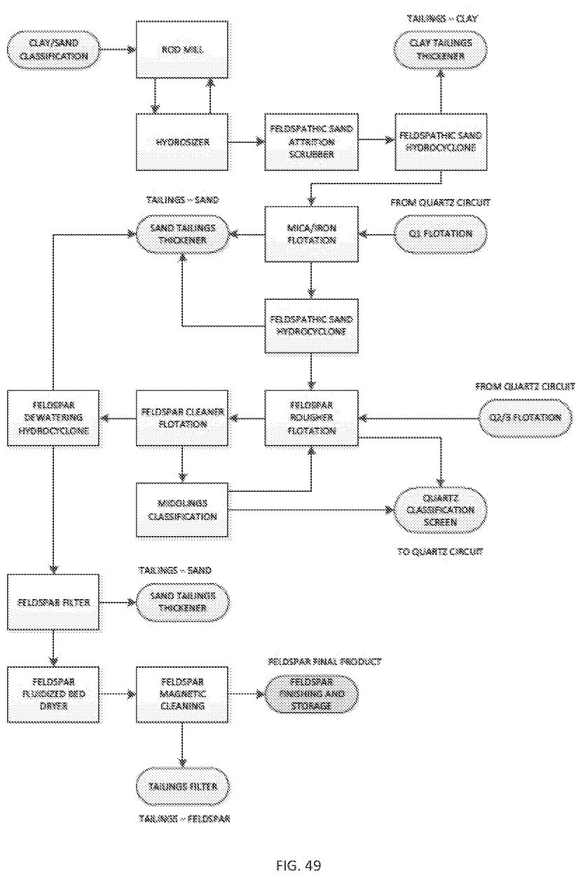

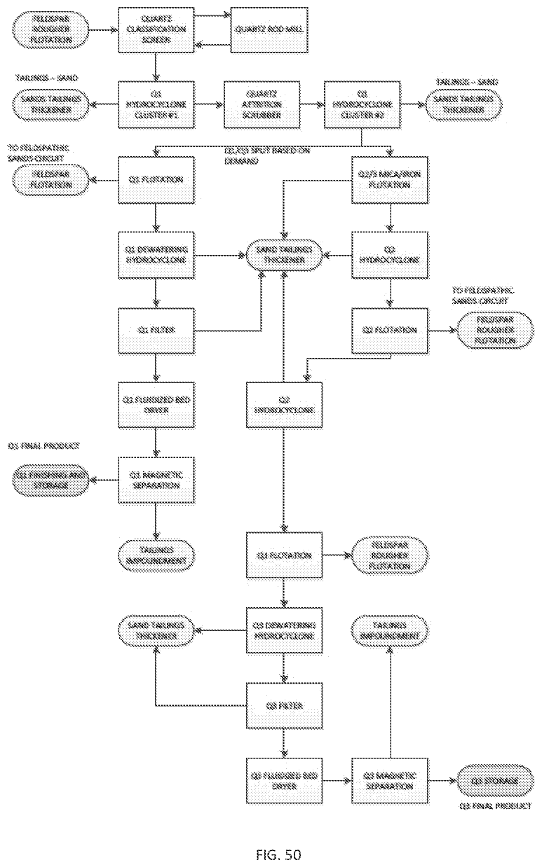

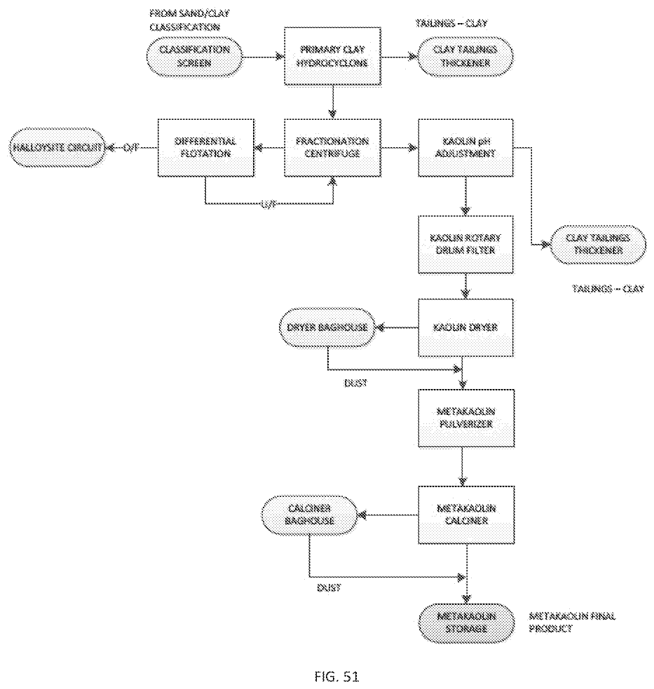

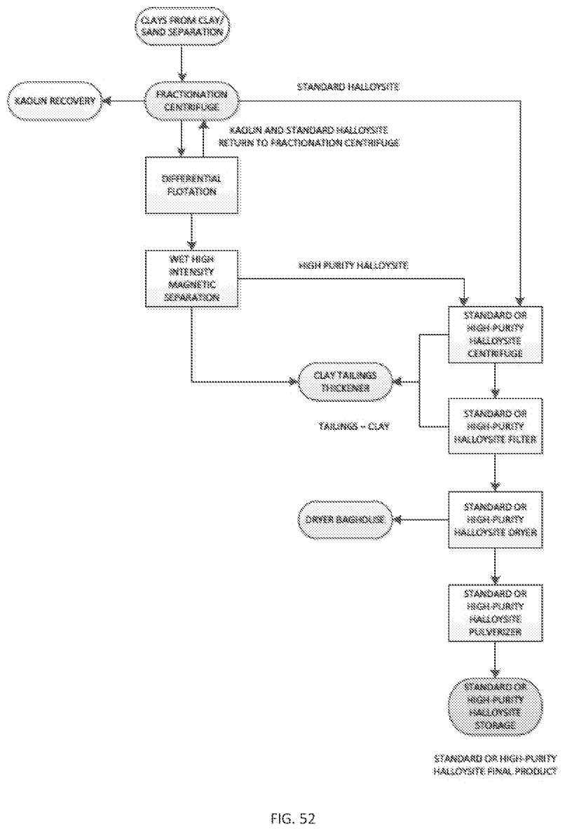

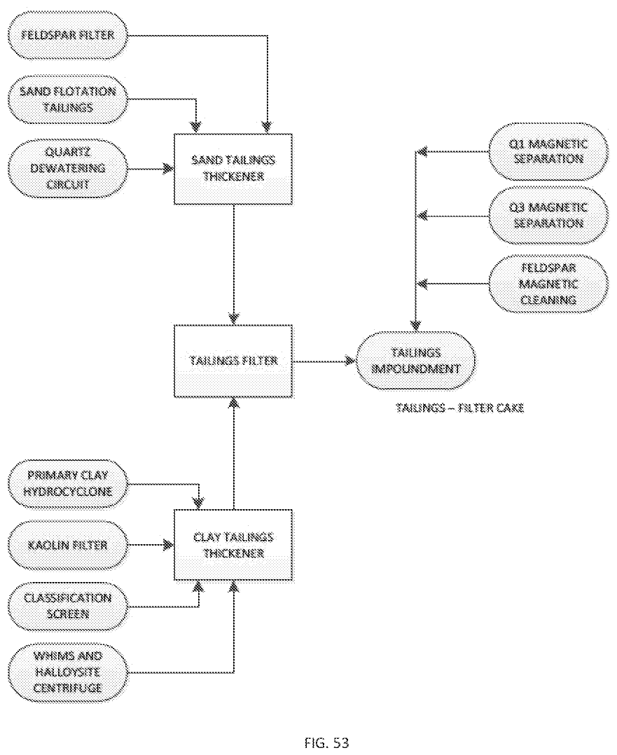

In another exemplary embodiment, a method of the present disclosure comprises the methodology illustrated in FIGS. 48-53. The methodology involves steps, not all of which are necessarily employed in each and every situation, but which may have similarities to other exemplary embodiments provided herein.

The various embodiments are provided by way of example and are not intended to limit the scope of the disclosure. The described embodiments comprise different features, not all of which are required in all embodiments of the disclosure. Some embodiments of the present disclosure utilize only some of the features or possible combinations of the features. Variations of embodiments of the present disclosure that are described, and embodiments of the present disclosure comprising different combinations of features as noted in the described embodiments, will occur to persons with ordinary skill in the art. It will be appreciated by persons with ordinary skill in the art that the present disclosure is not limited by what has been particularly shown and described herein above. Rather the scope of the disclosure is defined by the appended claims.

What is claimed is:

1. A system for processing halloysite from primary and/or secondary global mineral deposits, comprising liberating, separating and concentrating processes.

2. The system as claimed in claim 1, wherein mineral liberation consists of chemical, hydraulic, and mechanical dispersion of a mineral slurry system.

3. The system as claimed in claim 1, wherein the system for processing halloysite exploits the unique physical and chemical characteristics of the mineral halloysite.

4. The system as claimed in claim 1, wherein the processing system specifically increases and expands a relative density differential value of halloysite.

5. The system as claimed in claim 2, wherein the separating process comprises a wet processing method comprising a step of utilizing and optimizing/maximizing intrinsic buoyance forces (Fb) of halloysite.

6. The system as claimed in claim 5, wherein the optimizing intrinsic Fb of halloysite is for buoyancy enhancements via chemical and thermal treatments to remove inter-lumen water to adjust dynamics of halloysite buoyancy and density axioms in fluid mediums.

7. The system as claimed in claim 1, wherein the concentration and separation processes comprise specifically designed mechanical and hydraulic reactors, classifiers, and separation vessels with optimized operating parameters to transform composite mineral slurries into concentrated halloysite products with desired purity and quality on commercial scales.

8. The system as claimed in claim 7, wherein the mechanical and hydraulic reactors and vessels comprise:
a) modified simple agitated vessel/tank;
b) slurry inlet;
c) bottom outlet/discharge;
d) homogeneous mixing;
e) axial/radial flow agitation;
f) variable speed motor; and
g) side mounted variable height discharge valves for slurry reactors and vessels and/or overflow discharge for “thickener” type vessel systems.

9. The system as claimed in claim 8, wherein the mechanical and hydraulic reactors and vessels utilize both static and dynamic separation principals.

10. The system as claimed in claim 9, wherein time of separation is relative and a function of a slurry depth.

11. The system as claimed in claim 9, wherein a production of a halloysite product with desired quality and purity is based on separation dynamics of buoyancy, drag, and gravitation forces.

12. The system as claimed in claim 7, wherein one optimized operating parameter is Maximum Slurry Column Height for efficient separation and concentration being a minimum of 12″-16″ and maximum slurry column height of 40′-50′ as defined by slurry solids, purity desires, and production required.

13. The system as claimed in claim 7, wherein another optimized operating parameter is operating solids being at 3%-50%.

14. The system as claimed in claim 7, wherein the classifiers are accelerated gravity centrifuges utilizing and separating based on relative density and particle morphologies of the mineral slurry systems.

15. The system as claimed in claim 1, further comprising selective quality measures of particle size distribution using modified Stokes' Law and X-rays to determine halloysite concentration and impurity removal success.

16. The system as claimed in claim 1, carried out so as to significantly increase the commercial global quantities and volumes of halloysite from low-grade halloysite deposits.

17. A halloysite product with desired quality, purity, consistency, and homogeneity on commercial scales produced by a system for processing halloysite from primary and/or secondary global mineral deposits, comprising liberating, separating and concentrating processes.

18. The halloysite product as claimed in claim 17, wherein the halloysite product with enhanced purity and color/brightness is obtained by magnetic separation and/or leaching/bleaching.

19. The halloysite product as claimed in claim 17, wherein the halloysite product has improved and consistent particle morphology for enhancing product performance and value.
